(19) United States
(12) Patent Application Publication
(10) Pub. No.: US 2019/0329809 A1
(43) Pub. Date: Oct. 31, 2019

(54) ELECTRICALLY MOTORISED WHEEL, TRANSMISSION AND CONTROL MODULE, KIT, VEHICLE AND SYSTEM

(71) Applicant: Concourse Golf Pty Ltd, New South Wales (AU)

(72) Inventor: David Michael MACKAY, New South Wales (AU)

(21) Appl. No.: 16/349,943

(22) PCT Filed: Nov. 15, 2017
(86) PCT No.: PCT/AU2017/051258

§ 371 Date: May 14, 2019

(30) Foreign Application Priority Data
Nov. 15, 2016 (AU) 2016904651

(51) Int. Cl. B62B 5/00; B60K 7/00; B60L 15/20; B60K 17/04; B60K 1/04; B60L 53/14

(52) U.S. Cl. CPC B62B 5/0073; B60K 7/0007; B62B 5/004; B60L 15/20; B60K 17/043; B60K 1/04; A63B 55/61; B62B 5/0043; B60K 2007/0038; B60K 2007/0061; B60L 2220/44; B60K 2001/045; B62B 2202/404; B60L 53/14

(57) ABSTRACT

Disclosed is an electrically motorised wheel, transmission and control module, kit, vehicle and system. The electrically motorised wheel 100 is configured to releasably couple to a non-motorised wheeled vehicle. The electrically motorised wheel 100 includes: a ground engaging assembly 110; a coupling assembly 125 for releasably coupling the electrically motorised wheel to an axle 2000 of the vehicle 2700; and a housing 1902 configured to house: an electric motor 560 operatively coupled to the ground engaging assembly 110; a control system 505 including or coupled to an inertial measurement unit 540, which is stationary within the housing 1902 during motorised rotation of the electrically motorised wheel 100, and a controller 510 configured to control operation of the electric motor 560 based one or more sensor signals received from the inertial measurement unit 540; and a power source 520 electrically connected to the control system 505 and the electric motor 560.

### CROSS-REFERENCE TO RELATED APPLICATIONS

The present application claims priority from Australian Provisional Patent Application No. 2016904651 filed on 15 Nov. 2016, the content of which is incorporated herein by reference.

### TECHNICAL FIELD

The present invention relates to an electrically motorised wheel, transmission and control module, kit, vehicle and system. In one particular example, the present invention relates to converting a non-motorised wheeled vehicle to an electrically motorised vehicle.

### BACKGROUND

There are a number of non-motorised wheeled vehicles where a user is manually required to push or pull the vehicle along a surface via wheels. Examples of such non-motorised wheeled vehicles include golf buggies and prams. It would be highly advantageous to be able to motorise such non-motorised wheeled vehicles in a simple manner.

Whilst a number of motorised versions of these types of vehicles exist, converting a non-motorised wheeled vehicle to an electrically motorised vehicle is extremely challenging. Such a conversion can require specialised technical knowledge and can be time consuming.

Furthermore, such motorised vehicles may deviate off-course when travelling over a non-planar surface, thereby meaning that the user may be required to correct the travel direction of the motorised vehicle if possible. This may not be possible if the user is remote to the motorised vehicle.

Additionally, there have been problems in the past of users forgetting to turn off the power supply for such motorised vehicles meaning that the motorised vehicle may not be able to operate for an expected period of time. Once the power source can no longer electrically power the motorised vehicle, the user may need to manually push or pull the motorised vehicle which may be significantly difficult as the motor may be manually exercised during this movement.

Attempts have been made by others to provide an electrically motorised wheel, or a pair of electrically motorised wheels, which can be coupled to a non-motorised vehicle. However, these attempts have suffered from a number of problems.

For example, in instances where a pair of electrically motorised wheels are provided to be coupled to a non-motorised vehicle, the pair of electrically motorised wheels include a dedicated right wheel and a dedicated left wheel. This therefore requires the user to pay attention that the right wheel is coupled to the right side of the non-motorised vehicle and that the left wheel is coupled to the left side of the non-motorised vehicle, otherwise the wheels will operate in reverse thereby causing the non-motorised vehicle to travel in a reverse direction that expected. Additionally, if one of the wheels need to be replaced, the user needs to ensure that a dedicated right or left wheel is acquired for the respective wheel being replaced, otherwise the non-motorised vehicle will not travel correctly.

Additionally, these attempts require the user to walk with the converted vehicle in order to facilitate steering. This may not be advantageous in particular applications.

Therefore there is a need to alleviate one or more of the above-mentioned problems or at least provide a useful alternative.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### SUMMARY

This Summary is provided to introduce a selection of concepts in a simplified form that are further described below in the Detailed Description. This Summary is not intended to identify key features or essential features of the claimed subject matter, not is it intended to be used as an aid in determining the scope of the claimed subject matter.

In a first aspect there is provided an electrically motorised wheel to releasably couple to and convert a non-motorised wheeled vehicle to an electrically motorised vehicle, wherein the electrically motorised wheel includes:

a ground engaging assembly;

a coupling assembly for releasably coupling the electrically motorised wheel to an axle of the vehicle; and

a housing configured to house:
an electric motor operatively coupled to the ground engaging assembly;
a control system including or coupled to an inertial measurement unit, which is stationary within the housing during motorised rotation of the electrically motorised wheel, and a controller configured to control operation of the electric motor based one or more sensor signals received from the inertial measurement unit; and
a power source electrically connected to the control system and the electric motor.

In certain embodiments, the inertial measurement unit includes a three axis gyroscope and a three axis accelerometer.

In certain embodiments, the coupling assembly is configured to releasably couple the electrically motorised wheel to the axle of the vehicle in a first coupled position where rotation of the ground engaging assembly is controlled by the electric motor, and a second coupled position where rotation of the ground engaging assembly is not controlled by the electric motor.

In certain embodiments, the coupling assembly includes a pair of axially separated engagement components and an engagement actuator component, wherein actuation of the engagement actuator component causes the pair of axially separated engagement components to move between an engaged position and a disengaged position so as to allow the electrically motorised wheel to be axially movable between the first coupled position and the second coupled position.

In certain embodiments, the pair of axially separated engagement components include a first and second retaining clip, and wherein the engagement actuator component is a camshaft, wherein actuation of the camshaft simultaneously causes the first retaining clip to move from the engaged position to the disengaged position and the second retaining clip to move from the disengaged position to an intermediary position, wherein axial movement of the electrically motorised wheel causes a groove of the axle to align with the second retaining clip and self bias to the engaged position to engage the axle.

In certain embodiments, the electric motor is a bidirectional electric motor, wherein a direction of operation of the electric motor is controlled by the controller based on sensed acceleration indicated by the one or more sensor signals received from the inertial measurement unit.

In certain embodiments, the control system includes memory having stored therein mounting orientation data, wherein the controller uses the sensed acceleration indicated by the one or more sensor signals and the mounting orientation data to determine a mounting orientation of the electrically motorised wheel, wherein the direction of operation of the electric motor is controlled according to the mounting orientation.

In certain embodiments, the mounting orientation data includes a plurality of angular rotation ranges, wherein each angular rotation range has a respective mounting orientation, wherein the controller is configured to:

determine, based on the sensed acceleration indicated by the one or more sensor signals, a current angular rotation; and

determine a matching angular rotation range from the plurality of angular rotation ranges which the current angular rotation falls within, wherein the mounting orientation of the electrically motorised wheel is the respective mounting orientation of the matching angular rotation range.

In certain embodiments, the control system is configured to control an operating speed of the electric motor based on an angular velocity indicated by the one or more sensor signals received from the inertial measurement unit.

In certain embodiments, the electrically motorised wheel further includes a wireless communication device in communication with the controller for receiving a command signal from a user command device, wherein the controller operates the electric motor based upon the command signal.

In certain embodiments, in response to the controller receiving an initialisation request from the user command signal, the controller is configured to establish a wireless communication session with the user command device.

In certain embodiments, the housing at least partially houses a transmission assembly operatively connected between the electric motor and the ground engaging assembly, wherein the transmission assembly is configured to cause rotation of a ground engaging assembly of the electrically motorised wheel in response to actuation of the electric motor.

In certain embodiments, transmission assembly includes a hub having a mounting surface that is exposed from the housing which rotates relative to the housing.

In certain embodiments, the mounting surface includes a fastening arrangement to operatively connect a ground engaging assembly of the electrically motorised wheel to the hub such that rotation of the hub causes the ground engaging assembly to rotate therewith.

In certain embodiments, the ground engaging assembly includes:

an outer frame which is secured to the hub;

a rim coupled to the outer frame that surrounds a perimeter of the housing; and

a tyre secured to the rim.

In certain embodiments, the electrically motorised wheel further includes an inner cover which is secured to the housing, wherein the inner cover has a central hole for locating the coupling assembly, and one or more mounting holes located about the central hole for receiving a mounting leg, wherein the mounting leg is part of or coupled to the non-motorised wheeled vehicle.

In certain embodiments, wherein the central hole of the inner cover extends inwardly defining a hollow column housing the coupling assembly.

In certain embodiments, the coupling assembly includes a cap having a pair of resilient fingers, wherein each finger includes a notched end which engages a respective hole in the hollow column to retain the coupling assembly within the shaft in an assembled state.

In certain embodiments, the electrically motorised wheel further includes a chassis which is secured within the housing such that the chassis is rotationally stationary within the housing during motorised rotation of the electrically motorised wheel, wherein the hub is supported upon the chassis via a bearing such that the hub is rotatable relative to the chassis during motorised rotation of the electrically motorised wheel.

In certain embodiments, the transmission assembly includes a gear box assembly which is operatively coupled to the electric motor, wherein the gear box assembly includes a gear box housing which is supported within the housing by one or more vibration dampeners.

In certain embodiments, the transmission assembly further includes a pulley arrangement which is at least partially supported upon the chassis which is operatively connected between the gear box assembly and the hub.

In certain embodiments, the gear box housing is separated from the chassis by one or more further vibration dampeners.

In certain embodiments, the gear box housing supports a pulley which is operatively connected to the gear box assembly, wherein the pulley is further operatively connected to at least part of the pulley arrangement via a belt.

In certain embodiments, the controller includes a magnetic field sensor which is located substantially adjacent a portion of the hub, wherein the hub has embedded therein one or more magnets, wherein the controller is configured to:

receive, from the magnetic field sensor, one or more magnetic field sensor signals indicative of a rotational speed of the hub;

receive, from a motor controller of the motor, a signal indicative of a rotational speed of the motor; and

determining if a ratio of the rotational speed of the hub and the rotational speed of the motor changes over time, wherein in response to determining the change the controller is configured to stop operation of the motor.

In certain embodiments, the housing includes a first hollow passing therethrough, and the chassis has a second hollow passing therethrough, wherein the first and second hollows are coaxially aligned to locate therein the coupling mechanism for coupling the axle.

In certain embodiments, the second hollow of the chassis is defined by an open ended cylindrical section which rotatably supports thereabout the hub.

In certain embodiments, the electrically motorised wheel further includes a power source indicator which is in electrical connection with at least one of the controller and the electric power source, wherein the power source indicator is exposed by the housing to provide an indication of a level of electrical power stored by the power source.

In certain embodiments, the electrically motorised wheel further includes a charging device having a charging port exposed by the housing, wherein the charging device is in electrical connection with the power source.

In certain embodiments, the charging port has a magnet in order to magnetically retain a connector of an external power source to the charging port.

In certain embodiments, the electrically motorised wheel is an electrically motorised golf cart wheel to convert a non-motorised golf cart to an electrically motorised golf cart.

In a second aspect there is provided a transmission and control module for an electrically motorised wheel, wherein the transmission and control module includes:

a housing;

an electric motor housed within the housing;

a transmission assembly operatively connected to the electric motor and at least partially housed within the housing, wherein the transmission assembly is configured to cause rotation of a ground engaging portion of the electrically motorised wheel;

a control system housed within the housing and electrically coupled to the electric motor, wherein the control system includes or is coupled to an inertial measurement unit, which is stationary within the housing during motorised rotation of the electrically motorised wheel, and a controller configured to control operation of the electric motor based one or more sensor signals received from the inertial measurement unit; and

a power source housed within the housing and electrically connected to the control system and the electric motor.

In certain embodiments, the electric motor is a bidirectional motor, wherein a direction of operation of the electric motor is controlled by the control system based on sensed acceleration indicated by the one or more sensor signals received from the inertial measurement unit.

In certain embodiments, the control system includes a memory device having stored therein mounting orientation data, wherein the controller uses the sensed acceleration indicated by the one or more sensor signals and the mounting orientation data to determine a mounting orientation of the electrically motorised wheel, wherein the direction of operation of the electric motor is controlled according to the mounting orientation.

In certain embodiments, the mounting orientation data includes a plurality of angular rotation ranges, wherein each angular rotation range has a respective mounting orientation, wherein the controller is configured to:

determine, based on the acceleration indicated by the one or more sensor signals, a current angular rotation; and

determine a matching angular rotation range from the plurality of angular rotation ranges which the current angular rotation falls within, wherein the mounting orientation of the electrically motorised wheel is the respective mounting orientation of the matching angular rotation range.

In certain embodiments, the control system is configured to control an operating speed of the electric motor based on an angular velocity indicated by the one or more sensor signals received from the inertial measurement unit.

In certain embodiments, the transmission assembly includes a hub having a mounting surface that is exposed from the housing which rotates relative to housing.

In certain embodiments, the mounting surface includes a fastening arrangement to operatively connect a ground engaging portion of the electrically motorised wheel to the hub such that rotation of the hub causes the ground engaging portion to rotate therewith.

In certain embodiments, the transmission and control module includes a chassis which is secured within the housing such that the chassis is rotationally stationary within the housing during motorised rotation of the electrically motorised wheel, wherein the hub is supported upon the chassis via a bearing such that the hub is rotatable relative to the chassis during motorised rotation.

In certain embodiments, the transmission assembly includes a gear box assembly which is operatively coupled to the electric motor, wherein the gear box assembly includes a gear box housing which is supported within the housing by one ore more vibration dampeners.

In certain embodiments, the transmission assembly further includes a pulley arrangement at least partially supported upon the chassis which is operatively connected between the gear box assembly and the hub.

In certain embodiments, the gear box housing is separate to the chassis and spaced apart by one or more further vibration dampeners.

In certain embodiments, the gear box housing supports a pulley which is operatively connected to the gear box assembly, wherein the pulley is further operatively connected to at least part of the pulley arrangement via a belt.

In certain embodiments, the controller includes a magnetic field sensor which is located substantially adjacent a portion of the hub, wherein the hub has embedded therein one or more magnets, wherein the controller is configured to:

receive, from the magnetic field sensor, one or more magnetic field sensor signals indicative of a rotational speed of the hub;

receive, from a motor controller of the motor, a signal indicative of a rotational speed of the motor; and

determining if a ratio of the rotational speed of the hub and the rotational speed of the motor changes over time, wherein in response to determining the change the controller is configured to stop operation of the motor.

In certain embodiments, the transmission and control module further includes a wireless communication device in communication with the controller for receiving a user command signal from a user command device, wherein the controller operates the electric motor based upon the user command signal.

In certain embodiments, in response to the controller receiving an initialisation request from the user command device, the controller is configured to establish a wireless communication session with the user command device.

In certain embodiments, the housing includes a first hollow passing therethrough, and the chassis has a second hollow passing therethrough, wherein the first and second hollows are coaxially aligned to locate therein a coupling mechanism for coupling an axle of the electrically motorised wheel.

In certain embodiments, the second hollow of the chassis is defined by an open ended cylindrical section which rotatably supports thereabout the hub.

In certain embodiments, the transmission and control module includes a power source indicator which is in electrical connection with at least one of the controller and the electric power source, wherein the power source indicator is exposed by the housing to provide an indication of a level of electrical power stored by the power source.

In certain embodiments, the transmission and control module further includes a charging device including a charging port exposed by the housing, wherein the charging device is in electrical connection with the power source.

In certain embodiments, the charging port has a magnet in order to magnetically retain a connector of an external power source to the charging port.

In a third aspect there is provided a kit for converting a non-motorised wheeled vehicle to an electrically motorised vehicle, wherein the kit includes a first electrically motorised wheel and a second electrically motorised wheel according to the first aspect.

In certain embodiments, the kit includes a plurality of mounting adaptors to couple to a wheel supporting portion of the non-motorised wheeled vehicle, wherein each mounting adaptor provides the axle for releasable coupling by one of the coupling assemblies of one of the electrically motorised wheels.

In certain embodiments, each mounting adaptor includes a mounting leg which engages a portion of the housing of the respective electrically motorised wheel, wherein the mounting leg is non-coaxial with the respective axle.

In certain embodiments, the kit includes a user command device configured to:

receive, via an input device, a user command; and

transfer, to the control system of the first and second electrically motorised wheels, a signal indicative of or based upon the user command.

In certain embodiments, the kit includes a dock for attachment to the electrically motorised vehicle for docking the user command device, wherein the dock includes a one or more magnets and the user command device includes a ferromagnetic surface, wherein magnetic attraction between the one or more magnets of the dock and the ferromagnetic surface of the command device releasably retain the user command device in a docked position.

In certain embodiments, the user command device includes a controller including or coupled to a magnetic field sensor, wherein in the docked position the magnetic field sensor senses the one or more magnets of the dock and transfers an initialisation request to the first and second electrically motorised wheels to perform an initialisation process.

In certain embodiments, the kit converts a non-motorised golf cart into an electrically motorised golf cart.

In a fourth aspect there is provided an electrically motorised vehicle including:

non-motorised wheeled vehicle; and

a first electrically motorised wheel and a second electrically motorised wheel, wherein each electrically motorised wheel is adapted to the non-motorised wheeled vehicle and configured according to any one of claims 1 to 30.

In certain embodiments, a plurality of mounting adaptors are coupled to a wheel supporting portion of the non-motorised wheeled vehicle, wherein each mounting adaptor provides the axle for releasable coupling by one of the coupling assemblies of one of the electrically motorised wheels.

In certain embodiments, each mounting adaptor includes a mounting leg which engages a portion of the housing of the respective electrically motorised wheel, wherein the mounting leg is non-coaxial with the respective axle.

In a fifth aspect there is provided a system including:

the electrically motorised vehicle according to the fourth aspect, wherein the system includes a user command device configured to:

receive, via an input device, a user command; and

transfer, to the control system of at least one of the first and second electrically motorised wheels, a signal indicative of or based upon the user command for operating the respective electric motor of at least one of the first and second electrically motorised wheels.

In certain embodiments, the system further includes a dock attached to the electrically motorised vehicle for docking the user command device, wherein the dock includes a one or more magnets and the user command device includes a ferromagnetic surface, wherein magnetic attraction between the one or more magnets of the dock and the ferromagnetic surface of the command device releasably retain the user command device in a docked position.

In certain embodiments, the user command device includes a controller including or coupled to a magnetic field sensor, wherein in the docked position the magnetic field sensor senses the one or more magnets of the dock and transfers an initialisation request to the first and second electrically motorised wheels to perform an initialisation process.

In a sixth aspect there is provided an electrically motorised wheel to releasably couple to and convert a non-motorised wheeled vehicle to an electrically motorised vehicle, wherein the electrically motorised wheel includes:

a ground engaging portion;

a coupling assembly for releasably coupling the electrically motorised wheel to an axle of the vehicle; and

a housing configured to house:
an electric motor operatively coupled to the ground engaging portion;
a control system; and
a power source electrically connected to the control system and the electric motor;

wherein the control system is configured to control operation of the electric motor based at least in part on a received user command.

In certain embodiments, the electrically motorised wheel includes an inertial measurement unit, integrated with or in communication with the control system, for generating inertial measurement data associated with the electrically motorised wheel.

In certain embodiments, the inertial measurement unit includes a three axis gyroscope and a three axis accelerometer, wherein the inertial measurement data includes at least one of gyroscopic and acceleration data in one or more axes.

In certain embodiments, the control system is in communication with a user command device for receiving user input indicative of the user command, wherein the control system is configured to control operation of the electric motor further based at least in part on a mounting status of the user command device, the mounting status being indicative of the user command device being mounted or remote to the vehicle.

In certain embodiments, the control system is configured to control the electric motor to cause the vehicle to travel at a first speed based on the user command when the user command device is mounted to the vehicle, and wherein the control system is configured to control the electric motor to cause the vehicle to travel at a second speed based on the user command when the user command device is remote to the vehicle, wherein the first speed is greater than the second speed.

In certain embodiments, the control system is in communication with a user command device for receiving user input indicative of the user command, wherein the control system is configured to control operation of the electric motor further based at least in part on a mounting status of the user command device, the mounting status being indicative of the user command device being mounted or remote to the vehicle, wherein the control system is configured to control the electric motor to cause the vehicle to travel when the user command device is mounted to the vehicle and the inertial measurement data is indicative of the vehicle being tilted greater than or equal to a tilt threshold, and wherein the control system is configured to control the electric motor to cause the vehicle to stop travelling when the user command device is remote to the vehicle and the inertial measurement data is indicative of the vehicle being tilted greater than or equal to the tilt threshold.

In certain embodiments, whilst the vehicle is travelling and the user command device is mounted to the vehicle, the user command device is configured to generate a warning in response to the vehicle being tilted greater than or equal to the tilt threshold.

In certain embodiments, the control system includes a wireless communication device to wireless communicate with the user command device.

In certain embodiments, the electrically motorised wheel further includes a switch, wherein coupling the coupling assembly to the axle causes the switch to connect the control system to the power source, wherein decoupling the coupling assembly from the axle causes the switch to disconnect the control system from the power source.

In certain embodiments, insertion of the axle within the coupling assembly urges a switch actuation member to actuate the switch to connect the control system to the power source, and wherein withdrawal of the axle from the coupling assembly causes the switch actuation member to be biasly actuated to disconnect the control system from the power source.

In certain embodiments, the control system is configured to:

determine or facilitate determination of a mounting orientation of the electrically motorised wheel relative to the vehicle using the inertial measurement data, wherein the mounting orientation is a left mounting orientation or a right mounting orientation; and

control operation of the electric motor further based at least in part on the mounting orientation.

In certain embodiments, the coupling assembly is configured to releasably couple the electrically motorised wheel to the axle of the vehicle in a first coupled position where rotation of the ground engaging portion is controlled by the electric motor, and a second coupled position where rotation of the ground engaging portion is not controlled by the electric motor.

In certain embodiments, the coupling assembly includes a pair of axially separated engagement components and an engagement actuator component, wherein actuation of the engagement actuator component causes the pair of axially separated engagement components to move in an out-of-phase manner between an engaged position and a disengaged position so as to allow the electrically motorised wheel to be axially movable between the first coupled position and the second coupled position.

In certain embodiments, the pair of axially separated engagement components include a first and second retaining clip, and wherein the engagement actuator component is a camshaft, wherein rotational actuation of the camshaft simultaneously cause the first retaining clip to move from the engaged position to the disengaged position and the second retaining clip to move from the disengaged position to an intermediary position, wherein axial movement of the electrically motorised wheel causes a groove of the axle to align with the second retaining clip and self bias to the engaged position to engage the axle.

In certain embodiments, a first wall and second wall that are coupled to the ground engaging portion define the housing.

In certain embodiments, the electrically motorised wheel further includes a support structure supporting the electric motor, the control system and the power source within the housing, wherein the support structure is rotatably coupled to the first and second walls via bearings such that rotation of the ground engaging portion caused by actuation of the electric motor results in the housing rotating relative to the support structure.

In certain embodiments, the electrically motorised wheel is an electrically motorised golf cart wheel to convert a non-motorised golf cart to an electrically motorised golf cart.

In a seventh aspect there is provided a kit for converting a non-motorised wheeled vehicle to an electrically motorised vehicle, wherein the kit includes a first electrically motorised wheel and a second electrically motorised wheel according to the first aspect.

In certain embodiments, the kit includes a user command device configured to:

receive, via an input device, the user command; and

transfer, to the control system of the first and second electrically motorised wheels, a signal indicative of or based upon the user command.

In a eighth aspect there is provided a vehicle including:

a non-motorised golf cart having an axle;

a first electrically motorised wheel and a second electrically motorised wheel, wherein each electrically motorised wheel includes:
a ground engaging portion;
a coupling assembly for releasably coupling the respective electrically motorised wheel to the axle of the non-motorised golf cart; and

a housing configured to house:
an electric motor operatively coupled to the ground engaging portion;
a control system; and
a power source electrically connected to the control system and the electric motor;

wherein the control system of the first and second electrically motorised wheels is configured to control operation of the respective electric motor based at least in part on a received user command.

In a ninth aspect there is provided a system including:

the vehicle according to the eighth aspect; and

a user command device configured to:
receive, via an input device, the user command; and
transfer, to the control system of the first and second electrically motorised wheels, a signal indicative of or based upon the user command.

In a tenth aspect there is provided an electrically motorised wheel to releasably couple to and convert a non-motorised wheeled vehicle to an electrically motorised vehicle, wherein the electrically motorised wheel includes:

a coupling assembly for releasably coupling the electrically motorised wheel to an axle of the vehicle;

an electric motor operable to rotate the electrically motorised wheel;

an inertial measurement unit for generating inertial measurement data associated with the electrically motorised wheel;

a control system including or in communication with the inertial measurement unit, wherein the control system includes or is in communication with an interface for receiving a user command; and

a power source electrically connected to the control system and the electric motor;

wherein the control system is configured to control operation of the electric motor based at least in part on at least some of the inertial measurement data and the user command.

In a eleventh aspect there is provided a system for converting a non-motorised wheeled vehicle to an electrically motorised vehicle, wherein the system includes:

a first electrically motorised wheel and a second electrically motorised wheel, each electrically motorised wheel including:
a coupling assembly for releasably coupling the respective electrically motorised wheel to an axle of the vehicle;
an electric motor operable to rotate the respective electrically motorised wheel;
an inertial measurement unit for generating inertial measurement data associated with the respective electrically motorised wheel;
a control system including or in communication with the inertial measurement unit;
a power source electrically connected to the control system and the electric motor; and

a user command device, in communication with the control systems of the first and second electrically motorised wheels, for receiving one or more commands from a user;

wherein at least one of the user command device, the control system of the first electrically motorised wheel, and the control system of the second electrically motorised wheel generate control data for controlling operation of the first and second electrically motorised wheels based upon the user command and the inertial measurement data of the first and second electrically motorised wheels.

In a twelth aspect there is provided a system for converting a non-motorised wheeled vehicle to an electrically motorised vehicle, wherein the system includes:

an electrically motorised wheel including:
a coupling assembly for releasably coupling the electrically motorised wheel to an axle of the vehicle;
an electric motor selectively operable to rotate the electrically motorised wheel;
a control system, integrated or in communication with the inertial measurement unit; and
a power source electrically connected to the control system and the electric motor; and

the user command device configured to:
determine a mounting status of the user command device, the mounting status being indicative of the user command device being mounted or remote to the vehicle;
receive a user command from the user for operating the electrically motorised wheel; and
transfer data indicative of or based upon the user command;

wherein the control system is configured to control operation of the electric motor based at least in part on the mounting status and the user command.

In an thirteenth aspect there is provided an electrically motorised wheel to releasably couple to and convert a non-motorised wheeled vehicle to an electrically motorised vehicle, wherein the electrically motorised wheel includes:

a coupling assembly for releasably coupling the electrically motorised wheel to an axle of the vehicle;

a switch having a first position when the coupling assembly is decoupled from the axle and a second position when the coupling assembly is coupled to the axle;

an electric motor selectively operable to rotate the electrically motorised wheel;

a power source in electrical communication with the switch and the electric motor; and

a control system which is disconnected from the power source in response to the switch being in the first position, and connected to the power source in response to the switch being in the second position such that the control system is able to control operation of the electric motor.

In a fourteenth aspect there is provided an electrically motorised wheel to releasably couple to and convert a non-motorised wheeled vehicle to an electrically motorised vehicle, wherein the electrically motorised wheel includes:

an electric motor operable to rotate the electrically motorised wheel;

a power source in electrical communication with the electric motor; and

a control system to control operation of the electric motor based on a user command received via an interface; and

a coupling assembly for releasably coupling the electrically motorised wheel to an axle of the vehicle in a first coupled position where rotation of the electrically motorised wheel is controlled by the electric motor, and a second coupled position where rotation of the electrically motorised wheel is not controlled by the electric motor.

In a fifteenth aspect there is provided an electrically motorised wheel to releasably couple to and convert a non-motorised wheeled vehicle to an electrically motorised vehicle, wherein the electrically motorised wheel includes:

a ground engaging portion;

a coupling assembly for releasably coupling the electrically motorised wheel to an axle of the vehicle; and

an electric motor operatively coupled to the ground engaging portion;

a control system; and

a power source electrically connected to the control system and the electric motor;

wherein the control system is configured to control operation of the electric motor based at least in part on a received user command.

Other aspects and embodiments will be realised throughout the detailed description of the examples.

### BRIEF DESCRIPTION OF FIGURES

The example embodiment of the present invention should become apparent from the following description, which is given by way of example only, of a preferred but non-limiting embodiment, described in connection with the accompanying figures.

FIG. 1 is an isometric rear and outer side view of an example of an electrically motorised wheel;

FIG. 2 is an isometric rear and inner side view of the electrically motorised wheel of FIG. 1;

FIG. 3 is an exploded view of the mechanical components and the power source of the electrically motorised wheel of FIG. 1;

FIG. 4 is an exploded view from a reverse angle of the mechanical components and the power source of the electrically motorised wheel of FIG. 1;

FIG. 5 is a block diagram of electrical components of the electrically motorised wheel of FIG. 1 and electrical components of the user command device;

FIG. 6 is an outer side view of another example of the electrically motorised wheel;

FIG. 7 is an inner side view of the electrically motorised wheel of FIG. 6;

FIG. 8 is an front view of the electrically motorised wheel of FIG. 6;

FIG. 9 is an exploded view of the electrically motorised wheel of FIG. 6;

FIG. 10 is a perspective view of a portion of the inner side of the electrically motorised wheel coupled to the axle and mounting member of a golf cart assembly;

FIG. 11 is an exploded view of an alternate example of a coupling assembly for the electrically motorised wheel of FIG. 1 or 6;

FIG. 12 is an outer side view of a further example of the electrically motorised wheel;

FIG. 13 is a rotated inner side view of the electrically motorised wheel of FIG. 12;

FIG. 14 is a rotated inner side view of the electrically motorised wheel of FIG. 12 coupled to a mounting adaptor in an engaged position;

FIG. 15 is a rotated inner side view of the electrically motorised wheel of FIG. 12 coupled to the mounting adaptor in an unengaged position;

FIG. 16 is an end view of the electrically motorised wheel of FIG. 12 coupled to the mounting adaptor in an unengaged position;

FIG. 17 is an exploded rotated view of an inner cover and the coupling mechanism;

FIG. 18 is a cross-sectional view of the electrically motorised wheel through line A-A of FIG. 14;

FIG. 19 is an exploded rotated outer side view of the electrically motorised wheel of FIG. 12;

FIG. 20 is an exploded rotated inner side view of the electrically motorised wheel of FIG. 12;

FIG. 21 is an exploded rotated outer side view of the electrically motorised wheel of FIG. 12, wherein the ground engaging assembly is further exploded;

FIG. 22 is an exploded rotated inner side view of the electrically motorised wheel of FIG. 12, wherein the ground engaging assembly is further exploded;

FIG. 23 is a further exploded rotated outer side view of the electrically motorised wheel of FIG. 12 and a mounting arrangement of a leg of the non-motorised vehicle;

FIG. 24 is an exploded view of a transmission and control module of the electrically motorised wheel of FIG. 12;

FIG. 25 is a reverse exploded view of the transmission and control module of the electrically motorised wheel of FIG. 12;

FIG. 26 is a magnified view of a first and second electrically motorised wheel coupled to the pair of legs of a non-motorised vehicle;

FIG. 27 is a rotated side view of a non-motorised vehicle retrofitted with a first and second electrically motorised wheel;

FIG. 28 is a isometric view of an example of a user command device;

FIG. 29 is an isometric view of an example of a dock for the user command device;

FIG. 30 is a rotated view of an example of an alternate mounting member for a vehicle; and

FIG. 31 is a rotated view of an example of an alternate inner cover including a plurality of mounting holes for receiving the alternate mounting member of FIG. 30.

### DETAILED DESCRIPTION

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

The terminology used herein is for the purpose of describing particular embodiments and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

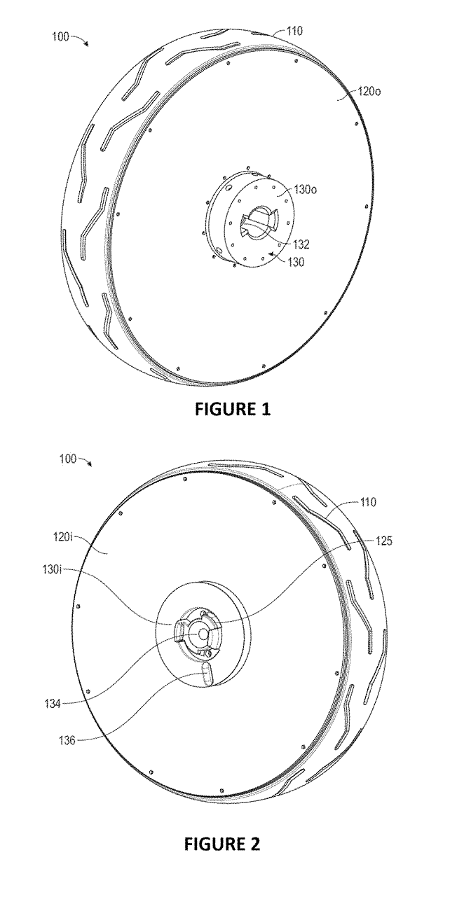

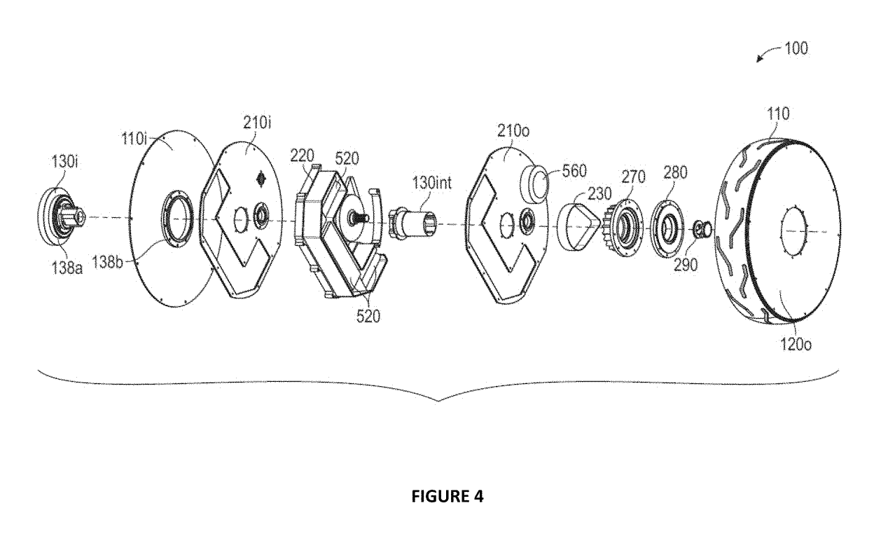

Referring to FIGS. 1 to 5, there is shown an example of an electrically motorised wheel 100 to releasably couple to and convert a non-motorised wheeled vehicle to an electrically motorised vehicle. The electrically motorised wheel 100 includes a ground engaging assembly 110, a coupling assembly 125, a housing 110i, 110o for housing an electric motor 560, a control system 505 and a power source 530. The coupling assembly 125 is configured to releasably couple the electrically motorised wheel 100 to an axle 2000 of the vehicle. The electric motor 560 is operatively coupled to the ground engaging assembly 110. The control system 560 is configured to control operation of the electric motor 560.

Due to the electrically motorised wheel 100 being a self contained unit in the sense that the electric motor 560, the control system 505 and power source 530 are coupled to the wheel body and housed within the housing 110i, 110o of the wheel 100, the electrically motorised wheel 100 can be easily coupled to an axle 2000 of a non-motorised wheeled vehicle via the coupling assembly 125 to convert the non-motorised vehicle into a motorised wheeled vehicle.

In certain embodiments, the non-motorised wheeled vehicle may have two electrically motorised wheels 100 coupled to the axle(s) 2000 of the vehicle. In this configuration, the ground engaging assemblies 110 can be rotated at different speeds in response to user commands or autonomously in order to steer the wheeled vehicle (such as in a selected direction) using a differential steering arrangement. It will be appreciated that in some instances a single motorised wheel may be utilised for the vehicle. For example, the front wheel of a three-wheeled golf cart assembly could be replaced with a single electrically motorised wheel 100. For the purposes of clarity, examples will herein be described in relation to a vehicle having two electrically motorised wheels 100 releasably coupled thereto.

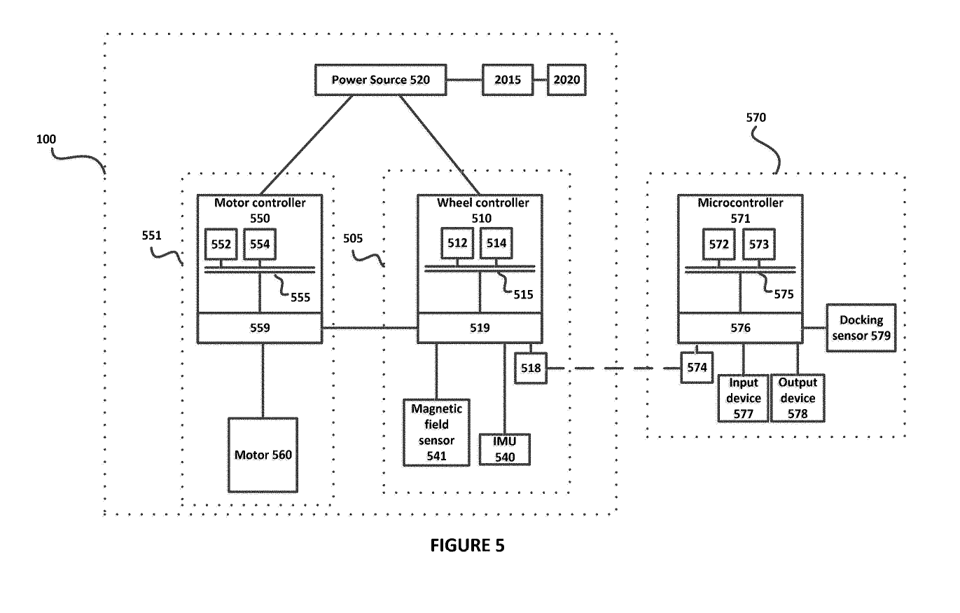

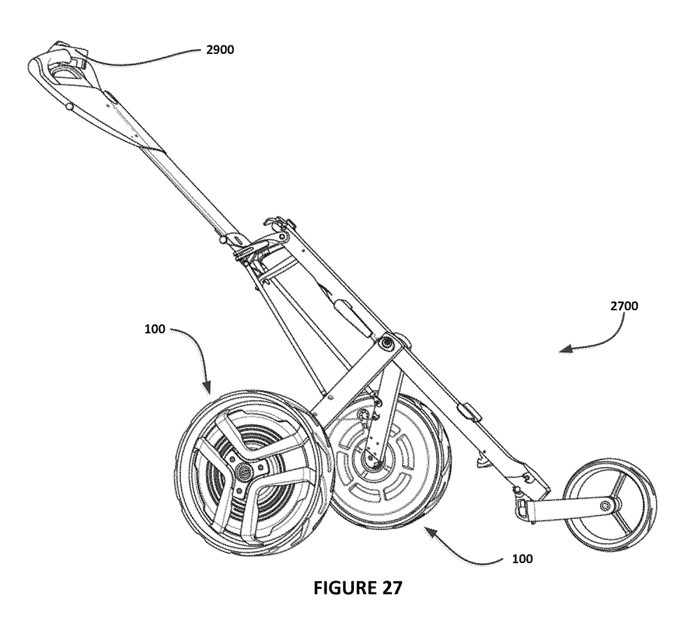

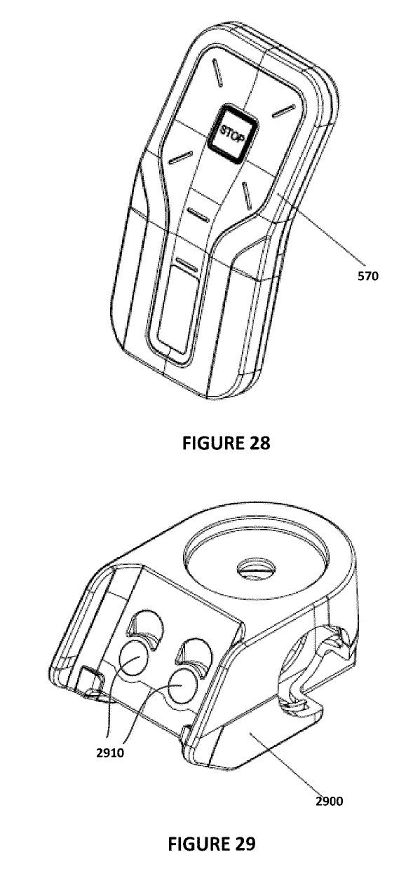

Each electrically motorised wheel 100 can be controlled via a user command device 570 which is shown in FIG. 28 and the electrical component of the user command device 570 are shown in FIG. 5. In one form, the user command device 570 can operate as a remote control device which includes an input device 577 to allow a user to provide input indicative of a user command. The user command device 570 is configured to communicate a signal indicative of or at least partially based upon the user command to the control system 505 of each electrically motorised wheel 100 such that the control system(s) 505 controls actuation of the electric motor(s) 560 at least partially based on the user command. In a preferred form, the user command device 570 includes a controller 571 such as a microcontroller including a processor 572, memory 573, an i/o interface 576 which is coupled to an input device 577, an output device 578 and a communication device 574 or medium for communicating with the control system 505. Components 572, 573, 576 are coupled together via a bus 575.

In a preferred form, the communication device 574 of the user command device 570 is a wireless communication device which enables wireless communication with the electrically motorised wheel 100. However, it will be appreciated that the signal could alternatively be communicated from the user command device 570 to each electrically motorised wheel 100 via a physical medium such as an electrical cable or the like.

In the preferred form where the communication device 574 of the user command device 570 is a wireless communication device, the control system 505 of each electrically motorised wheel 100 includes or is in communication with a wireless communication device 518 to enable wireless communication therebetween as shown by the dashed line in FIG. 5. The wireless communication devices 574, 518 of the user command device 570 and the electrically motorised wheel(s) 100 respectively can be provided in the form of Bluetooth communication devices, wherein communication between the user command device 570 and the electrically motorised wheel(s) 100 occur using Bluetooth protocol such as Bluetooth Low Energy (BLE) or classic Bluetooth. It will be appreciated that other wireless communication protocols and specifications can be utilised, such as Wi-Fi, Zigbee or the like.

In a preferred form, the wireless communication device 574 of the user command device 570 operates as master of wireless communication session and the wireless communication device 518 acts as a slave. Prior to a communication session having been established, the wireless communication device 574 acts as a peripheral and the wireless communication device 518 acts as a central. When the control system 505 of each electrically motorised wheel 100 is awoken from a sleep mode by receiving an initialisation signal from the user command device, a wireless communication session is established during initialisation with the wireless communication device 574 based on paired data stored in memory 514 of the control system 505 which identifies the master device. In one form, in order to pair the wireless communication device 518 of either wheel 100 with the wireless communication device 574 of the user command device 570, the user may connect, disconnect and reconnect a charging connector to a charging port 2020 of the electrically motorised wheel 100 within a threshold period of time (e.g. less than 1 or 2 seconds), wherein in response a controller 510 of the control system 505 detecting the sequence of electrical power connections and disconnections within the threshold period of time, the controller 510 controls the wireless communication device 518 to conduct a pairing operation with the wireless communication device 574 of the user command device.

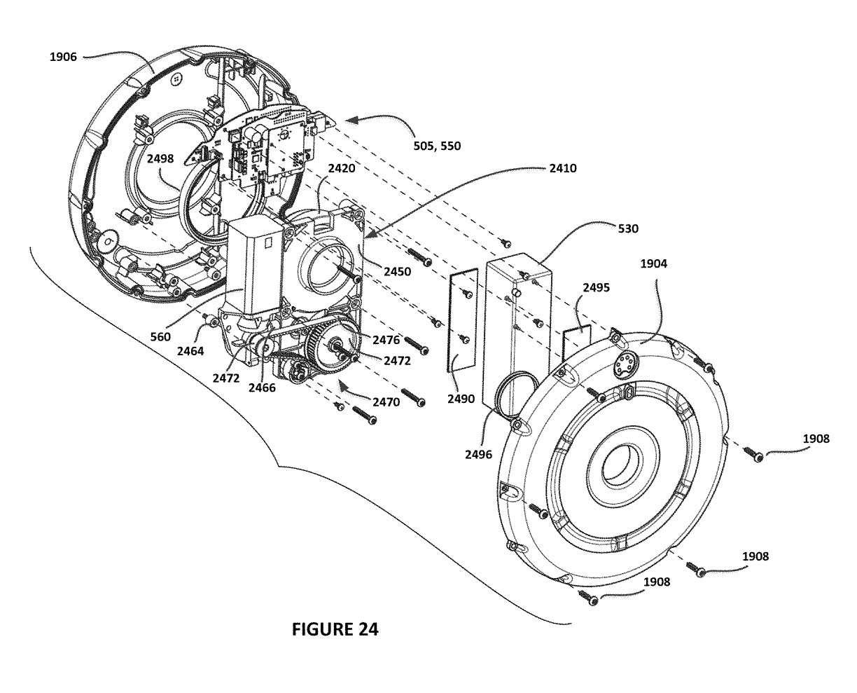

Continuing to refer to FIG. 5, the control system 505 of the electrically motorised wheel 100 is electrically coupled (or couplable as explained herein) with the power source 530 and the electric motor 560. The power source 530 can be provided in the form of a rechargeable electric battery. In one form, the rechargeable electric battery 520 may be provided in the form of a lithium ion battery. In one form as shown in FIG. 24, the battery 530 is supported by double sided tape 2490 and a foam strip 2495.

In a preferred form, the control system 505 includes a processing system including a first microcontroller 510 and a second microcontroller 550 provided in the form of a dedicated motor controller. The first microcontroller 510 includes a processor 512, memory 514 and i/o interface 518 interconnected together by a bus 515. The first microcontroller 510 includes the wireless communication device 518 connected via the i/o interface 519. The motor controller 550 together with the motor 560 define a motor assembly 551. The motor controller 550 includes a processor 552, memory 554 and i/o interface 559 interconnected together by a bus 555. As mentioned above, the control system 505 includes or is in communication with the communication device 518 such as a Bluetooth communication device to enable wireless communication with the user command device 570. The control system 505 is also in communication with one or more sensors 540, 541 which are coupled to the first microcontroller 510 via the i/o interface 519.

The first microcontroller 510 of each motorised wheel 100 is configured to sample or receive sensor data from the one or more sensors 540, 541. The first microcontroller 510 (also referred to as a wheel controller) is also configured to control communication with the user command device 570 using the wireless communication device 518. The first microcontroller 510 can also be configured to transfer motor control commands to the second microcontroller 550 via the i/o interface 519, wherein the motor controller 550 is electrically coupled to the electric motor 560. Due to the electric actuation of the electric motor 560 preferably being synchronised with the motor controller 550, the preferred embodiment includes two microcontrollers 510, 550 performing separate functions. The first and second microcontrollers 510, 550 can be in electrical communication such as tracks on the same PCB or via an electrical ribbon or some form of data cable such as a serial cable or the like. It will be appreciated that whilst this arrangement is preferred, it is possible to utilise a single microcontroller which performs the functions collectively.

Whilst in FIG. 5 the wireless communication device 518 is depicted as being electrically coupled to the controller 510 via i/o interface 519, in another form the wireless communication device 518 is integrated with the controller 510. In a preferable form, the wireless communication device 518 is a Nordic nRF51822 Bluetooth low energy transceiver.

In a preferred form, the first microcontroller 510 is STM32 microcontroller. In other forms, the first microcontroller can be provided as an ESP8266 microcontroller.

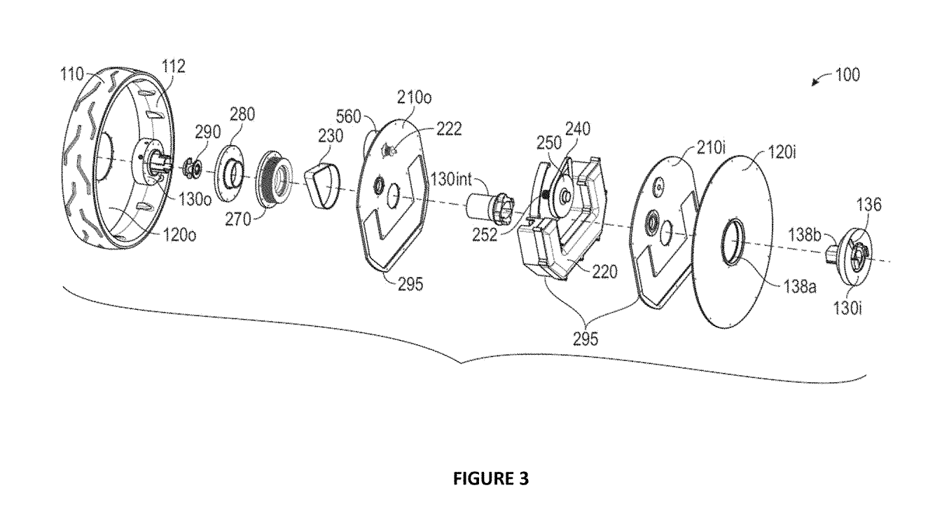

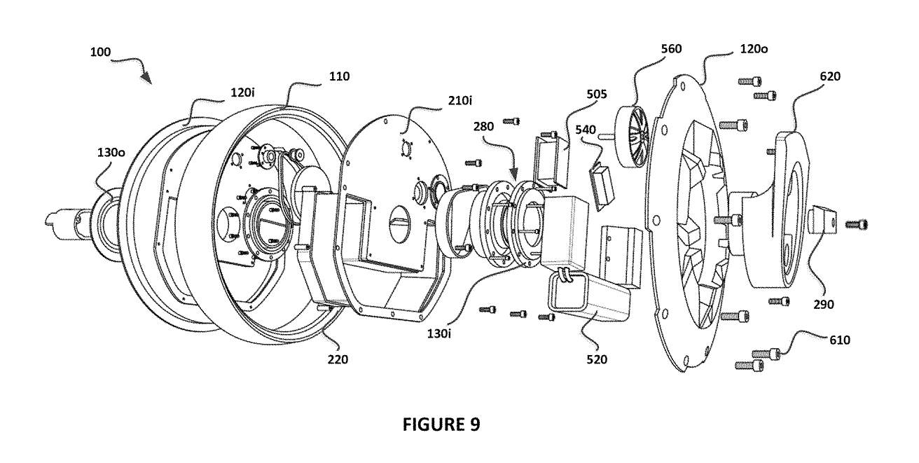

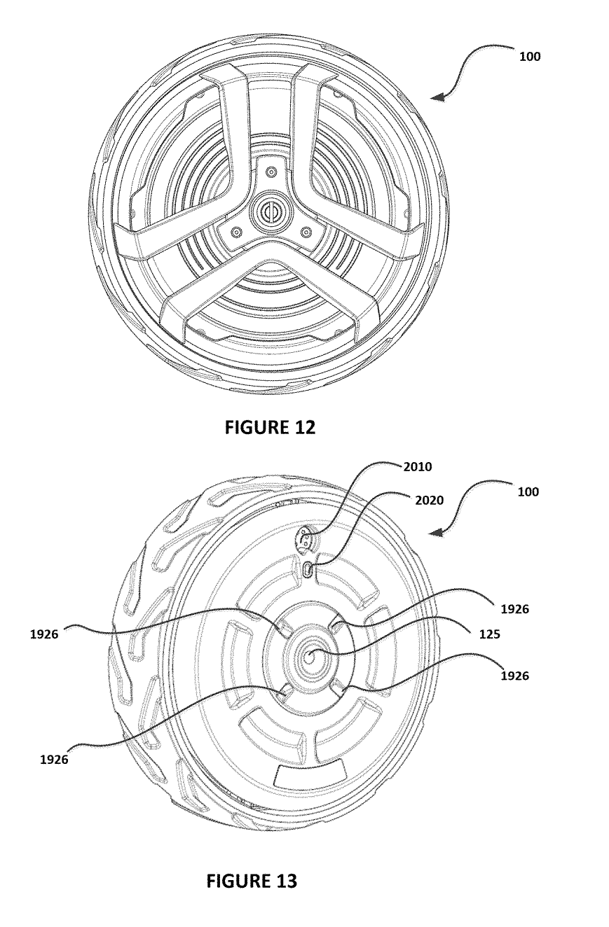

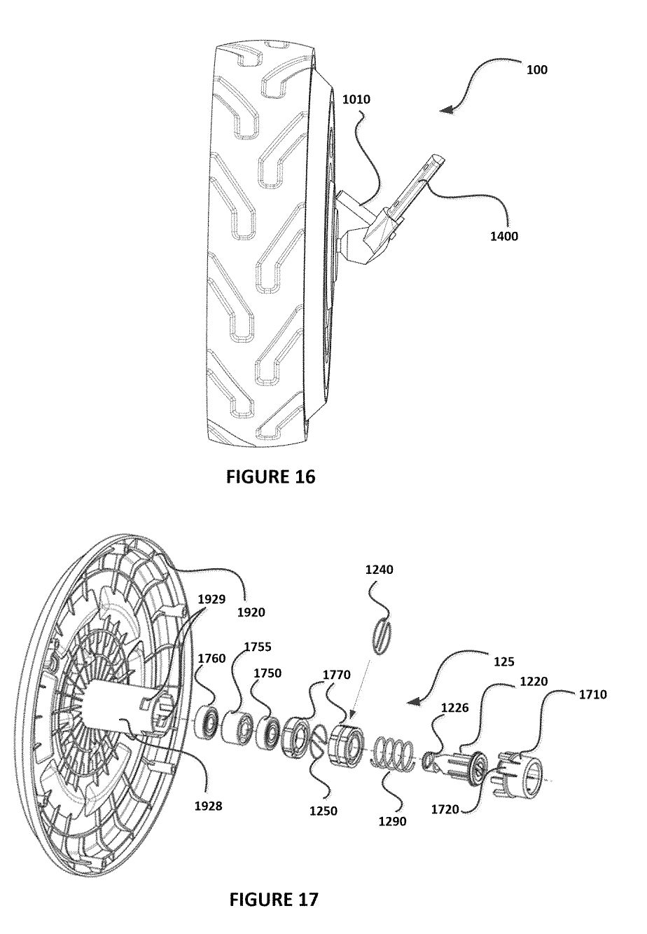

In a preferred form as shown in FIGS. 12 to 25, the electric motor 560 is provided in the form of a brushless DC motor. In a preferred form, the brushless DC motor has an 80W rating. However, in the examples shown in FIGS. 3, 4 and 9, the electric motor is provided in the form of a brushless disc motor.

As mentioned above, the control system 505 can include or be in communication with one or more sensors 540, 541 which can include an inertial measurement unit 540. In the preferred embodiment, the inertial measurement unit 540 is not integrated with the first microcontroller 510 but rather is in electrical communication therewith via the i/o interface 519. However, it will be appreciated that in other embodiments it is possible that the first microcontroller 510 can have an integrated inertial measurement unit. Advantageously the inertial measurement unit is rotationally stationary within the housing during motorised rotation such that the operation of the electric motor can be controlled based on the one or more sensor signals received by the controller from the inertial measurement unit. This thereby allows a determination of a mounting orientation and course correction as explained in further detail below.

In certain embodiments, the inertial measurement unit 540 is a six axis inertial measurement unit which can include a tri-axis gyroscope and a tri-axis accelerometer. The first microcontroller 510 can sample inertial measurement data from the inertial measurement unit 540 which is indicative of gyroscopic and acceleration data in one or more axes, and preferably three axes. In optional forms, the inertial measurement unit 540 can also include a digital compass wherein the inertial measurement data can be indicative of the digital compass data.

The microcontroller 510 can be configured to use the inertial measurement data to generate or facilitate the generation of motor commands for instructing the motor controller 550. In particular, the control system 505 is configured to control an operating speed of the electric motor 560 based on an angular velocity (i.e. gyroscopic data) indicated by the one or more sensor signals received from the inertial measurement unit. For example, the inertial measurement data can be indicative of the vehicle travelling over non-planar ground causing the vehicle to divert off a desired direction indicated by the user command device 570. As such, the microcontroller 510 can process the inertial measurement data to generate motor commands to correct the travel direction/course of the vehicle. In one particular arrangement where two electrically motorised wheels 100 are coupled to the vehicle, it is possible that only one of the controllers 510 of the pair of motorised wheels 100 adjusts the speed of the respective motor for a period of time in order to achieve differential speed steering to achieve course correction. In one form, one of the wheels 100 is set as a master wheel during initialisation, wherein the master wheel is configured to perform speed adjustment based on the respective one or more sensor signals received from the IMU 540. In one form, the user command device 570 instructs one of the controllers 510 of the wheels 100 to be the master wheel.

In optional embodiments, the microcontroller 510 may transfer the inertial measurement data to the microcontroller 571 of the user command device 570 to generate the motor commands which are then transferred to the microcontroller 510 via the communication device 518 which in turn is transferred to the motor controller 550 via the i/o interface 519. This may be desired in the event that the inertial measurement data from both wheels 100 need to be processed together to generate two set of motor commands for the wheels 100. In another option, the microcontrollers 510, 571 may operate as a distributed processing system to generate the motor commands. However, in a preferred form, only one of the controllers of the electrically controlled wheels 100 generates commands based on the sensed signals, thus it is not necessary to implement a distributed processing arrangement.

The first microcontroller 510 can also receive data from the motor controller 550 indicative of pulses generated by a sensor of the motor 560 which are indicative of speed of the motor 560. The sensor may be provided in the form of a hall effect sensor although other arrangements of odometers or the like are possible. As will be discussed herein, the user may provide a user command for the vehicle to travel forward a selected distance, wherein the first microcontroller 510 uses the pulses and data stored in memory indicative of a distance travelled between pulses to determine the distance which the vehicle has travelled in order to determine when the motor 560 should stop actuation. The sensed pulses are also used by the first microcontroller to track and store in memory 514 or 554 a total distance travelled.

Each controller 510 preferably is in communication with a further sensor for sensing the rotational speed of the electrically motorised wheel. In one form, the controller includes or is coupled to a magnetic field sensor 541 which is located substantially adjacent a rotating portion of the wheel, such as a hub 2420 of the wheel 100 as shown in further examples in FIGS. 12 to 25. The hub 2420 has embedded therein one or more magnets 1895 which are located about the circumference. The controller 510 is configured to receive, from the magnetic field sensor 541, one or more magnetic field sensor signals indicative of a rotational speed of the hub 2420. The controller 510 is then configured to receive, from a motor controller 550 of the motor 560, a signal indicative of a rotational speed of the motor 560 as discussed above. The controller 510 is then configured to determine if a ratio of the rotational speed of the hub 2420 and the rotational speed of the motor 560 changes over time, wherein in response to determining the change the controller is configured to stop operation of the motor 560. An error indicator may be displayed by the user command device 540.

In one form, the microcontroller 571 of the user command device can be provided in the form of a STM32 microcontroller although other controllers such as a ESP8266 microcontroller can be used. An input device 577 in the form of a plurality of keys/buttons can be electrically coupled to the microcontroller 571 via the interface 576. The keys/buttons can include a forward, back, left, right and stop button. Additionally, the output device 578 of the user command device 570 can be provided in the form of a LEDs coupled to the i/o interface 576 of the microcontroller 571 for displaying user feedback. In certain embodiments, additional output devices may be provided such as a speaker or the like to emit sound. Additionally, the user command device 570 can include a lock button similar to that used for smart phones and the like so as to restrict unintended operation of the user command device when located in the user's pocket or the like.

The memory 573 of the user command device 570 has stored therein a user command device program for operating the output device 578 such as a display or LEDs providing user feedback and for generating data indicative of user commands which are transferred to the electrically motorised wheel(s). The user command device program can also perform processing upon various signals and data received from the wheels 100 to determine motor commands which are transferred to the control system of the electrically motorised wheel. In some embodiments, the microcontroller 510 of the electrically motorised wheels 100 and the microcontroller 571 of the user command device 570 operate as a distributed processing system where processing of signals and data to generate motor commands can be performed in a distributed manner.

The user command device 570 can be releasably coupled to a dock 2900 of the vehicle such that the user command device is releasably mounted to the vehicle. However, it is possible for the user command device to be unmounted from the vehicle and operate as a remote control device. In one form, the user command device can generate data indicative of a mounting status of the user command. In particular, as shown in FIG. 5, the user command device 570 can include a docking sensor 579 which is activated when the user command device is mounted within the dock, wherein an electrical signal is received by the microcontroller 571 via the i/o interface 576. The docking sensor 579 may be provided in the form of a push button which is pressed against the dock when mounted. However, other mode sensors can be implemented, for example an RFID reader which reads an RFID circuit attached to the dock. In a preferred embodiment, the user command device includes a hall effect sensor 579 which senses magnets 2910 of the dock 2900 which also magnetically retain the user command device 570 to the dock 2900, wherein one or more signals received from the hall effect sensor 579 by the controller 571 of the user command device 570 indicate the mounting status. In one form, in the event that the user command device 570 is awoken from a sleep mode based on the sensing of the magnets, the user command device generates and transfers via the wireless communication device 574 an initialisation request to the one or more wheels 100 to undertake one or more initialisation actions.

The determined mounting status can be used to control the operation of the electrically motorised wheels 100. For example, the control system 505 of each electrically motorised wheel 100 can be configured to control the respective electric motor 560 to cause the vehicle to travel at a first speed when the user command device 570 is mounted to the vehicle. However, the control system 505 of the electrically motorised wheels 100 can be configured to control the electric motor 560 to cause the vehicle to travel at a second speed, which is less than the first speed, in the event that the user command device 570 is remote to the vehicle.

In another example, the control system 505 of the electrically motorised wheels 100 can be configured to control the electric motor 560 to cause the vehicle to travel when the user command device 570 is mounted to the vehicle and the inertial measurement data is indicative of the vehicle being tilted greater than or equal to a tilt threshold stored in memory 514. Whilst the vehicle is travelling and the user command device 570 is mounted to the vehicle, the user command device 570 may be configured to generate a warning in response to the vehicle being tilted greater than or equal to the tilt threshold. For example, the warning may be presented via the output device 578. However, the control system 505 of the electrically motorised wheels 100 can be configured to control the electric motor 560 to cause the vehicle to stop travelling when the user command device 570 is remote to the vehicle and the inertial measurement data is indicative of the vehicle being tilted greater than or equal to the tilt threshold.

In further embodiments, if the control system 505 is controlling the motor 560 to cause the vehicle to travel and the control system 505 can no longer communicate with the user command device 570 (for example, the user command device is out of range of the vehicle), the control system 505 can stop operating the motor 560 so that the vehicle no longer continues travelling. Additionally, in the event that the user command device 570 cannot communicate with one of the wireless communication devices 518 of either wheel 100, the user command device 570 communicates a stop command to the remaining wheel 100 in communication with the user command device 570 to stop operation of the respective wheel 100.

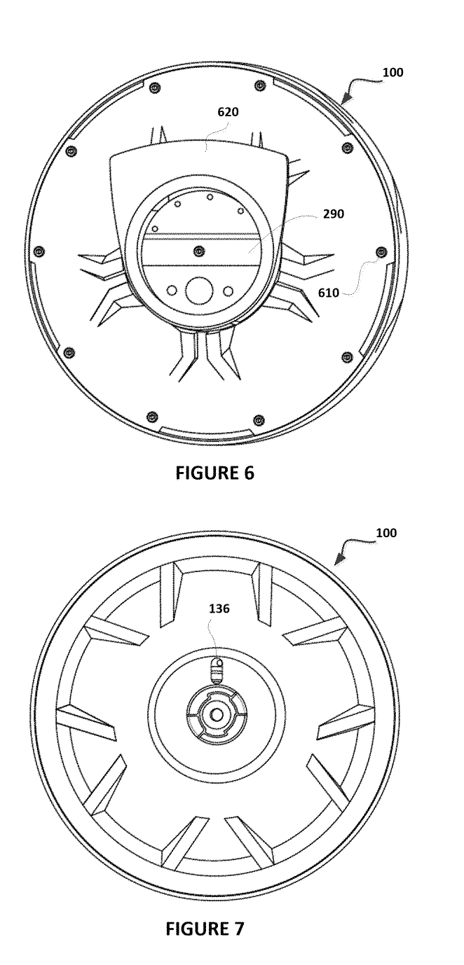

As shown in FIG. 1, the coupling assembly 125 can include a push activated button 290 to disengage the coupling assembly of the wheel 100 from the axle of the vehicle. The coupling assembly can be provided in a central portion of the outer portion hub component 130o. An alternatively shaped push activated button 290 is shown in FIG. 6. Again, the elongated push activated button 290 can be urged inwardly to cause the coupling assembly 125 to disengage the axle 2000.

As shown in FIG. 6, the wheel 100 can include a handle portion 620 which extends from the hub component 130. The handle 620 can assist with engagement of the coupling assembly to the axle as wheel may require rotation after the axle is inserted into the handle such that a mounting member in the form of a drive pin 1010 is guided into engagement with the hole 136 of the inner hub component 130i. As the wheels are rotated in opposite directions in order for the drive pin 1010 to engage with the inner hub component 130i, the inertial measurement data generated by each wheel can be used to determine whether each wheel is a left or right mounted wheel.

Referring to FIGS. 3, 4 and 9 there is shown exploded views of a first and second example of the electrically motorised wheel. The electrically motorised wheel 100 includes a first wall (herein an inner wall) 120i and second wall (herein an outer wall) 120o that are coupled to the ground engaging portion 110 to define the housing. The ground engaging portion 110 is provided in the form of a rubber tyre portion with a solid rim 112. One or more of the walls can be fastened to the rim of the ground engaging portion with fasteners.

The electrically motorised wheel 100 further include a support structure 295 provided in the form of a pair of frames 210o, 210i, supporting the electric motor 560, the control system 505 and the power source 520 within the housing. The support structure 295 is rotatably coupled to the inner and outer walls via bearings 280, 138 (comprising outer bearing component 138a and inner bearing component 138b) such that rotation of the ground engaging portion 110 caused by actuation of the electric motor 560 results in the housing being rotated relative to the support structure 295. The inertial measurement unit 540 is also coupled to the support structure 295 such that it is stationary during motorised rotational movement of the ground engaging portion 110 of the wheel 100.

The frames 210i, 210o have mounted thereto a power source compartment 220 for housing the power source 520. As shown in the exploded views, the power source compartment 220 has a substantially “C” shaped profile to house the power source 520 which is configured to have a corresponding “C” shaped profile.

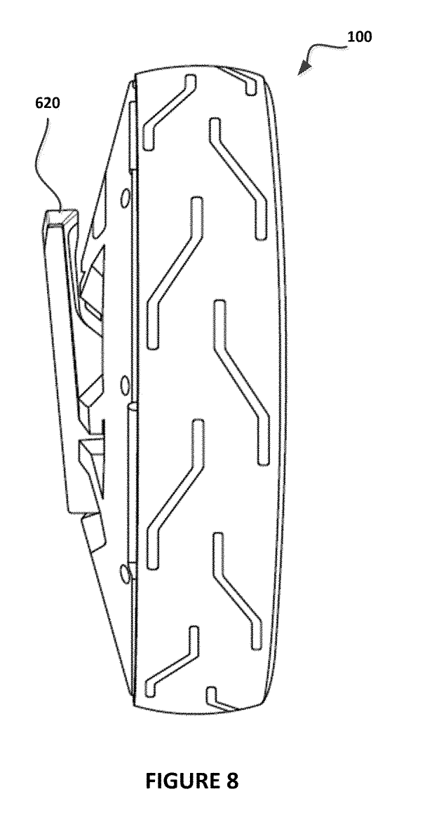

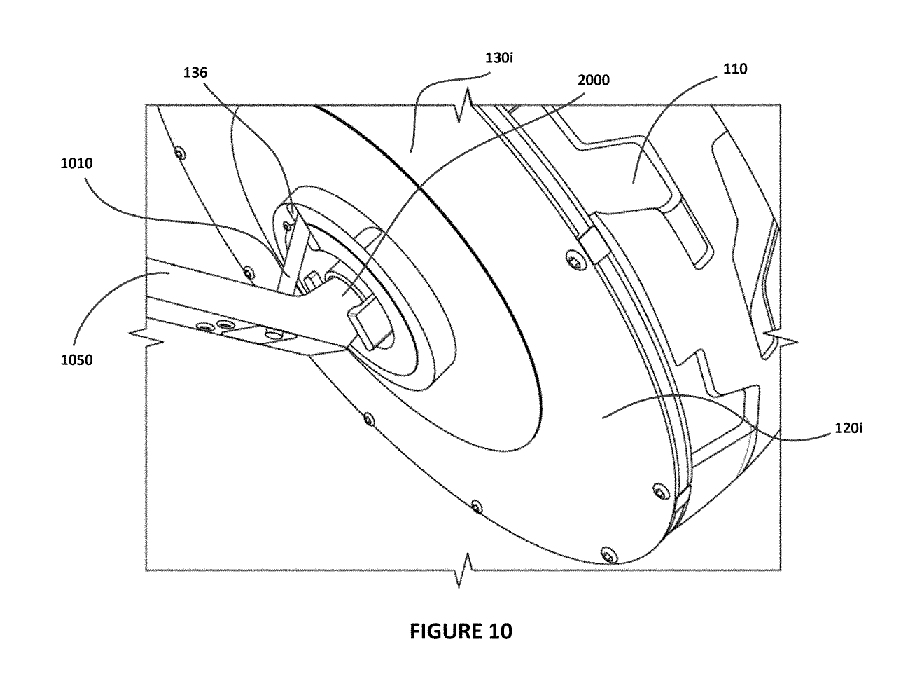

The hub 130 of the electrically motorised wheel 100 of FIGS. 3, 4 and 9 can include an outer hub component 130o, an inner hub component 130i and an intermediary hub component 130int which couples the outer hub component 130o and the inner hub component 130i together through holes of the frames 210i, 210o to form the hub 130. The hub 130 is coupled to or includes bearings 138, 280 such that the hub 130 together with the support structure 295 remain stationary relative to the rotating housing of the electrically motorised wheel 100. As shown in FIGS. 2, 7 and 10, the inner hub component include a hole which receives therein a drive pin 1010 (see FIG. 10) of the vehicle 1050. The drive pin causes the hub 130 to remain stationary which in turn causes the support structure coupled to the hub 130 to remain stationary whilst the walls 120i, 120o and the ground engaging portion 110 rotate due to actuation of the electric motor 560. As discussed in further examples, other arrangements are possible.

As shown in FIGS. 1 and 2, portions of the inner and outer hub components 130i, 130o are located on an outer surface of the in the inner and outer walls 120i, 120o of the housing. The inner and outer hub components 120i, 120o together with the walls 120i, 120o and the ground engaging portion 110 define an enclosed and protected space for housing the electrical components of the electrically motorised wheel 100.

The motor 560 is operatively coupled to a drive assembly such as a belt and pulley arrangement 222, 252, 240, 230, 270. In particular, as shown in FIG. 3, the housing of the electrically motorised wheel 100 includes a dual belt and pulley arrangement, wherein a pulley 270 of the belt and pulley arrangement is fixed to the inner side of the outer wall 120o of the housing. Thus the actuation of the electric motor 560 causes the pulley fixed to the inner side of the outer wall 120o to rotate the walls 120o, 120i and the ground engaging portion.

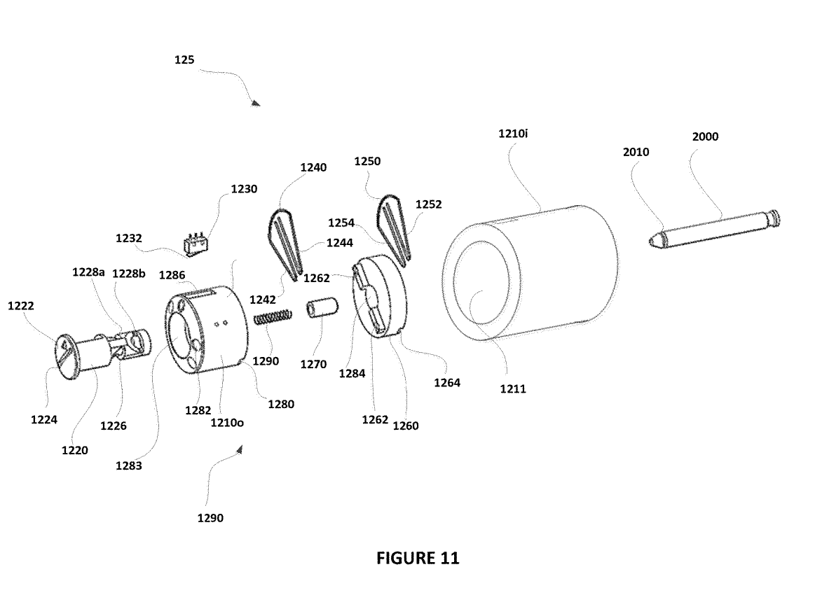

Referring to FIG. 11 there is shown an exploded view of an alternate coupling assembly 125 for the electrically motorised wheel 100 exemplified in FIGS. 1 and 6. In particular, the coupling assembly 125 includes a switch 1230 which is mounted in the hub components 1210i, 1210o of the coupling assembly 125. Coupling the electrically motorised wheel 100 to the axle 2000 via the coupling assembly 125 causes the switch 1230 to electrically connect the respective control system 505 to the power source 520. Decoupling the electrically motorised wheel 100 from the axle 2000 via the coupling assembly 125 causes the switch 1230 to disconnect the control system 505 from the power source 520. More specifically insertion of the axle 2000 within the coupling assembly 125 urges a switch actuation member 1270 to actuate the switch 1230 to electrically connect the control system 505 to the power source 520, and wherein withdrawal of the axle 2000 from the coupling assembly 125 causes the switch actuation member 1270 to be biasly move to open the switch thereby electrically disconnecting the control system 505 from the power source 520.

Referring more specifically to FIG. 11, the coupling assembly 125 includes a switch actuation member 1270 that rests against a spring 1290 located within a stem of an engagement actuator component 1220 of the coupling assembly 125. The switch 1230 includes a biased member 1232 which protrudes within an axle receiving aperture 1284 of the coupling assembly 125. When the axle 2000 is received within the axle receiving aperture 1284 of the coupling assembly 125, the end of the axle contacts the end of the switch actuation member 1270. When sufficient force is applied to insert the axle 2000 within the coupling assembly 125, the bias of the spring 1290 urging against the opposing end of the switch actuation member 1270 is overcome thereby allowing the switch actuation member 1270 to axially move within the axle receiving aperture 1284 and close the biased member 1232 of the switch 1230 such that the switch 1230 is maintained in a closed position by contact of the switch actuation member 1270. Due to the closure of the switch 1230, the power source 520 is electrically connected to the control system 505 thereby allowing the control system 505 to be operational. Generally, upon electrical power being provided to the electrically motorised wheel 100, the control system 505 undergoes an initialisation process including a network connection operation by attempting to establish a wireless communication session with the user command device 570.

When the user decouples the wheel 100 from the axle 200 by actuation of the engagement actuator component 1220, the spring 1290 biases the switch actuation member 1270 to move axially in the same direction as the axle 2000 being withdrawn from the axle receiving aperture 1284. The spring 1290 causes the switch actuation member 1270 to move out of contact with the biased member 1232 of the switch 1230 causing the switch 1230 to move to an open position resulting in the control system 505 being electrically disconnected from the power source 520. This feature is particularly advantageous as the user does not need to remember to turn the control system 505 on or off because the coupled or decoupled state of each electrically motorised wheel 100 controls the electrical operation of the control system 505.

Continuing with FIG. 11, the coupling assembly 125 is configured to releasably couple the electrically motorised wheel 100 to the axle 2000 of the vehicle in a first coupled position where rotation of the ground engaging portion 110 is controlled by the electric motor 560, and a second coupled position where rotation of the ground engaging portion 110 is not controlled by the electric motor 560. This feature is particularly advantageous where the power source 520 has insufficient electrical energy to cause the motorised vehicle to travel over the ground surface. By moving the wheel 100 to the second coupled position, the manual rotation of the wheel 100 does not manually exercise the motor 560 of the wheel, thereby making it easier to move the vehicle.

More specifically, the coupling assembly 125 includes a pair of axially separated engagement components 1240, 1250 operatively connected to the engagement actuator component 1220. The engagement actuator component 1220 causes the pair of axially separated engagement components 1240, 1250 to move in an out-of-phase manner between an engaged position and a disengaged position so as to allow the electrically motorised wheel 100 to be axially movable between the first coupled position and the second coupled position. In certain embodiments, the pair of axially separated engagement components 1240, 1250 are provided in the form of a first and second retaining clip 1240, 1250. The engagement actuator component 1220 has a stem 1226 providing a camshaft. Biased fingers 1242, 1244, 1252, 1254 of the retaining clips 1240, 1250 align with cams 1228a, 1228b of the camshaft 1226. For example, rotational actuation of the camshaft 1226 simultaneously cause fingers 1242, 1244 of the first retaining clip 1240 to splay and move from the engaged position to the disengaged position, and the splayed fingers 1252, 1254 of the second retaining clip 1250 move from the disengaged position to an intermediary position. Axial movement of the electrically motorised wheel 100 causes a groove 2010 of the axle 2000 to align with the second retaining clip 1250 in the intermediary position, wherein the fingers 1252, 1254 of the second retaining clip 1250 are self biased to engage the groove 2010 of the axle 2000 so that the coupling assembly 125 couples the axle 2000 in the second coupled position. Due to the axial movement of the wheel 100, the drive pin 1010 of the vehicle, as shown in FIG. 10, disengages from the hole 136 provided on the outer surface of the inner hub 130i. Due to the drive pin 1010 being disengaged from the inner hub 130i of the electrically motorised wheel 100, the inner hub 130i is able to freely rotate so that the motor 560 is not manually exercised during manual movement of the vehicle over the ground surface.

Referring more specifically to FIG. 11, the coupling assembly 125 receives an engagement assembly 1290 within a void 1211 of an inner hub component 1210i. The engagement assembly 1290 includes an outer hub component 1210o which receives within a hollow 1283 thereof the stem 1226 of an engagement actuator component 1224. An outer end of the outer hub component 1210o includes indicia 1282 to indicate the coupled position of the coupling assembly 125. An inner end of the outer hub component 1210o engages an anti-rotation disc 1260 having a pair of diametrically aligned ridges 1262 and grooves 1264 on opposing faces. The fingers 1242, 1244 of the first retaining clip 1240 surround the ridges 1262 and the fingers 1252, 1254 of the second retaining clip 1250 locate within the grooves 1264. The end portions of the fingers 1242, 1244, 1252, 1254 also engage cammed sections 1228a, 1228b of a portion of the stem 1226 protruding from the end of the outer hub component 1210o. The ridges 1262 of the anti-rotational disc 1260 engage with grooves in the inner end surface of the outer hub component 1210o and the grooves 1264 of the anti-rotational disc 1260 engage with grooves provided on an inner end wall of the void 1211 of the inner hub component 1210i. Due to this configuration of the anti-rotational disc 1260, when the engagement actuator component 1224 is rotated (such as a user inserting a coin or the like in a ridge 1224 of a button portion 1222 of the engagement actuator component and applying a rotational force), the retaining clips 1240, 1250 do not rotate within the hub component 1210i. However, due to the cammed profile of the stem 1226 of the engagement actuator component 1220, the fingers 1242, 1244, 1252, 1254 of the retaining clips 1240, 1250 alternate moving between engaged or disengaged positions. When the fingers 1242, 1244 of one of the retaining clips 1240 is moved from the engaged position to the disengaged position, the respective fingers 1242, 1244 are splayed by one of the cammed sections 1228a causing the fingers 1242, 1244 to disengage the groove 2010 of the axle 2000. Splayed fingers 1252, 1254 of the other retaining clip 1250 biasly move back into contact with the outer surface of the axle 2000 in an intermediary position. The wheel 100 can then be axially moved such that the self biased fingers 1252, 1254 of the other retaining clip 1250 slide over the outer surface of the axle 2000 until it aligns with the groove 2010. The bias of the fingers 1252, 1254 of the other retaining clip 1250 causes the fingers 1252, 1254 to become lodged within the groove 2010 of the axle 2000 thereby causing the wheel 100 to be coupled in the second coupled position. In this second coupled position, the drive pin 1010 of the vehicle is withdrawn sufficiently to not be protruding within hole 126 of the inner hub component 1210i such that when the vehicle is moved, the hub 120 is able to rotate such that the motor 560 is not manually exercised during manual movement of the vehicle.

In one form, the control system 505 of at least one of the electrically motorised wheels 100 can be configured to determine or facilitate determination of a mounting orientation of the electrically motorised wheel 100 relative to the vehicle using the sensor signals from the inertial measurement unit. In particular, the mounting orientation can be a left mounting orientation or a right mounting orientation. The control system 505 is further configured to control operation of the electric motor further based at least in part on the mounting orientation.

For example, if a particular wheel 100 is determined to have a left mounting orientation then the control system 505 can operate the electric motor 560 in a first direction, where in contrast if the wheel 100 is determine to have a right mounting orientation, then the electric motor 560 is operated in a second (opposite) direction. This feature is particularly advantageous as the user does not need to consider whether a wheel 100 is a “left wheel” or a “right wheel” when releasably coupling to the vehicle. Rather, the user simply couples the wheels 100 to the vehicle and the control system 505 of at least one of the wheels 100 determines the mounting orientation automatically based on the inertial measurement data including acceleration data. In some instances, the inertial measurement data may be transferred to the user command device 570 to determine the mounting orientation. In some instances, only inertial measurement data from one of the wheels 100 needs to be processed due to the opposite mounting wheel being applied to the opposing wheel 100. Therefore, in the event of the control system 505 of one of the wheels 100 determine a mounting status of “left wheel”, data indicative of this determination can be used to apply a “right wheel” mounting orientation to the opposing wheel 100. This feature is also particularly advantageous if a spare wheel needs to be purchased as it is not necessary for the user to purchase a spare left or right wheel or potentially a whole new pair of wheels.

In a preferable form used in relation to the electrically motorised wheel 100 depicted in FIGS. 12 to 25, the control system 505 includes memory 514 having stored therein mounting orientation data, wherein the controller 510 uses the sensed acceleration indicated by the one or more sensor signals of the IMU 540 and the mounting orientation data to determine a mounting orientation of the electrically motorised wheel 100, wherein the direction of operation of the electric motor 560 is controlled according to the determined mounting orientation. In one form, the mounting orientation data includes a plurality of angular rotation ranges, wherein each angular rotation range has a respective mounting orientation. The controller 510 is configured to determine, based on the sensed acceleration indicated by the one or more sensor signals, a current angular rotation. The controller 510 is then configured to determine a matching angular rotation range from the plurality of angular rotation ranges which the current angular rotation falls within, wherein the mounting orientation of the electrically motorised wheel 100 is the respective mounting orientation of the matching angular rotation range. An example of angular rotation ranges for left and right mounted wheels is provided below in Table 1.

TABLE 1
Example angular rotation ranges for
determining mounting orientation

| Left wheel mounting orientation | | Right wheel mounting orientation | |
|---|---|---|---|
| Min (degrees) | Max (degrees) | Min (degrees) | Max (degrees) |
| 57 | 89 | 271 | 303 |
| 147 | 179 | 181 | 213 |
| 237 | 269 | 91 | 123 |
| 327 | 359 | 1 | 33 |

Referring to FIGS. 12 to 25 there is shown a further example of an electrically motorised wheel 100 to releasably couple to and convert a non-motorised wheeled vehicle to an electrically motorised vehicle. The electrically motorised wheel 100 includes a ground engaging assembly 110, a coupling assembly 125 and a housing 110 configured to house an electric motor 560, a control system 505 and a power source 530. The coupling mechanism 125 is configured to releasably couple the electrically motorised wheel 100 to an axle 2000 of the vehicle. The electric motor 560 is operatively coupled to the ground engaging assembly 110. The control system 505 includes or is coupled to an inertial measurement unit 540, which is stationary within the housing 110. Furthermore, the control system 505 includes a controller 510 configured to control operation of the electric motor 560 based one or more sensor signals received from the inertial measurement unit 540. The power source 530 is electrically connected to the control system and the electric motor.

The electrical components of the electrically motorised wheel 100 of FIG. 1 are in common with the electrically motorised wheel of FIGS. 12 to 25. Therefore, for the purposes of clarity, these common portions and functions of the electrically motorised wheel 100 will not be redescribed but are instead incorporated into the following example.

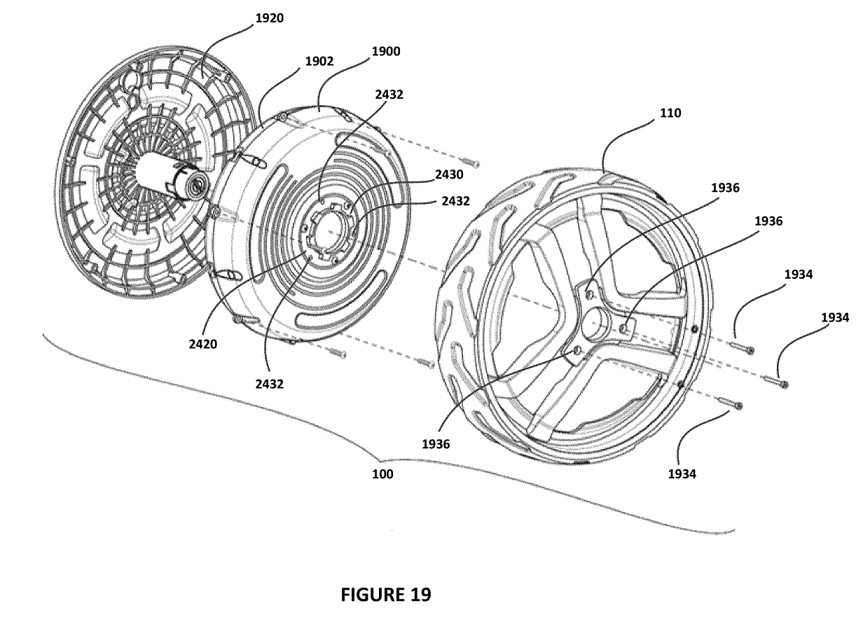

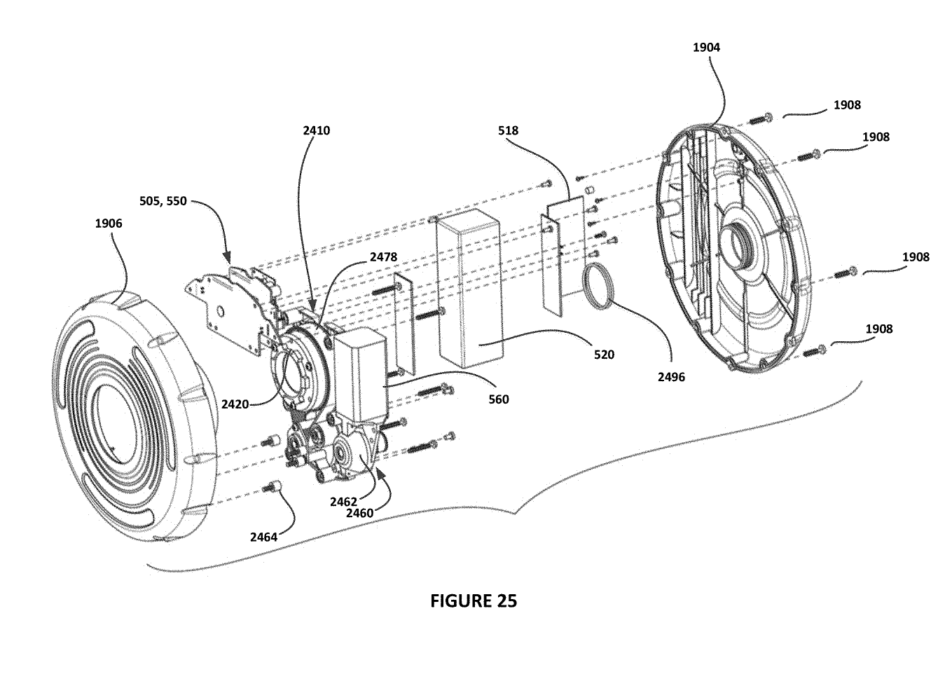

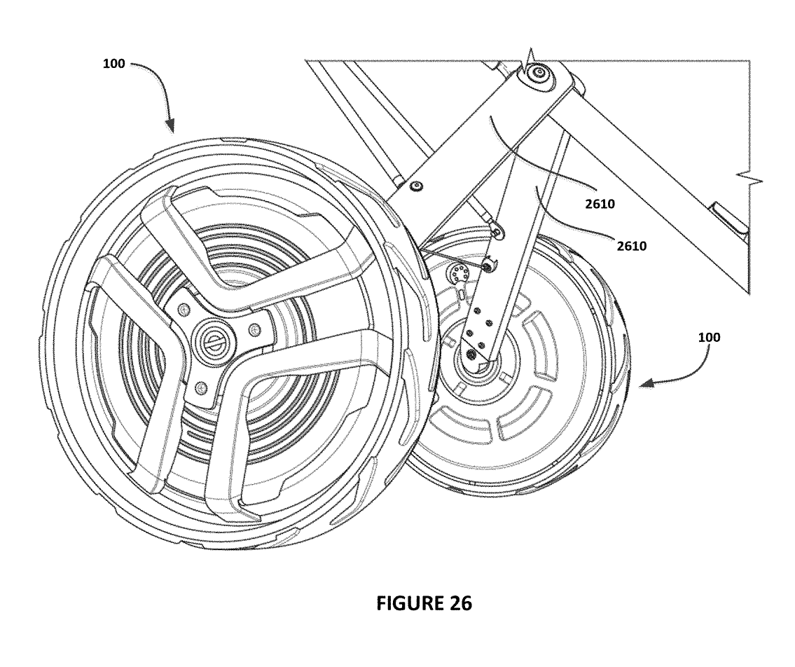

Referring more specifically to FIG. 19, the electrically motorised wheel 100 includes a transmission and control module 1900 for an electrically motorised wheel 100. As shown in FIGS. 24 and 25, the transmission and control module 1900 includes a housing 1902, the electric motor 560 housed within the housing 1902, a transmission assembly 2410 operatively connected to the electric motor 560 and at least partially housed within the housing 1902, the control system 505 housed within the housing 1902, and the power source 530 housed within the housing 1902 and electrically connected to the control system 505 and the electric motor 560. The transmission assembly 2410 is configured to cause rotation of the ground engaging assembly 110 of the electrically motorised wheel 100. The control system 505 is electrically coupled to the electric motor 560, wherein the control system 505 includes or is coupled to the inertial measurement unit 540, which is stationary within the housing 1902 of the electrically motorised wheel 100 during motorised rotation, and the controller 510 is configured to control operation of the electric motor 560 based one or more sensor signals received from the inertial measurement unit 540.

As shown in FIG. 19, an inner cover 1920 and an outer frame 1930, which is part of the ground engaging assembly 110, can be secured to the transmission and control module 1900 to form the electrically motorised wheel 100. As such, the transmission and control module 100 is a modular device that can be used for various types of self propelling wheel applications. Depending upon the type of self propelling wheel application, a customised ground engaging assembly, coupling assembly and cover can be attached to the transmission and control module 1900 for the specific application. For example, an electrically motorised wheel for a hospital bed wheel may have a substantially different type of ground engaging assembly compared to an electrically motorised wheel for a gold cart due to the types of surfaces which they travel over. For example, differently sized ground engaging assemblies with different tyre configurations could be provided for different applications.

As shown in FIGS. 24 and 25, the housing 1902 of the transmission and control module 1900 includes a first housing portion 1904 and a second housing portion 1906 that are secured together via screws 1908. Each housing portion is provided in the form of a shell half having a half toroidal profile.

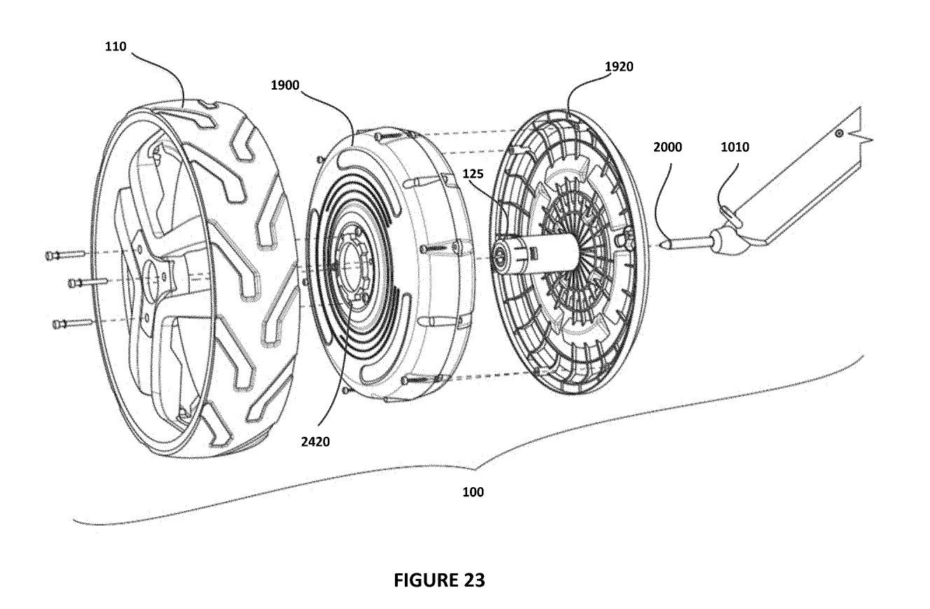

As shown in FIG. 23, the transmission assembly 2410 includes a hub 2420 having a mounting surface 2430 that is exposed from the housing 1902 which rotates relative to the housing 1902. The mounting surface 2430 includes a fastening arrangement 2432 to operatively connect the ground engaging assembly 110 of the electrically motorised wheel 100 to the hub 2420 such that rotation of the hub 2420 causes the ground engaging assembly 110 to rotate therewith.

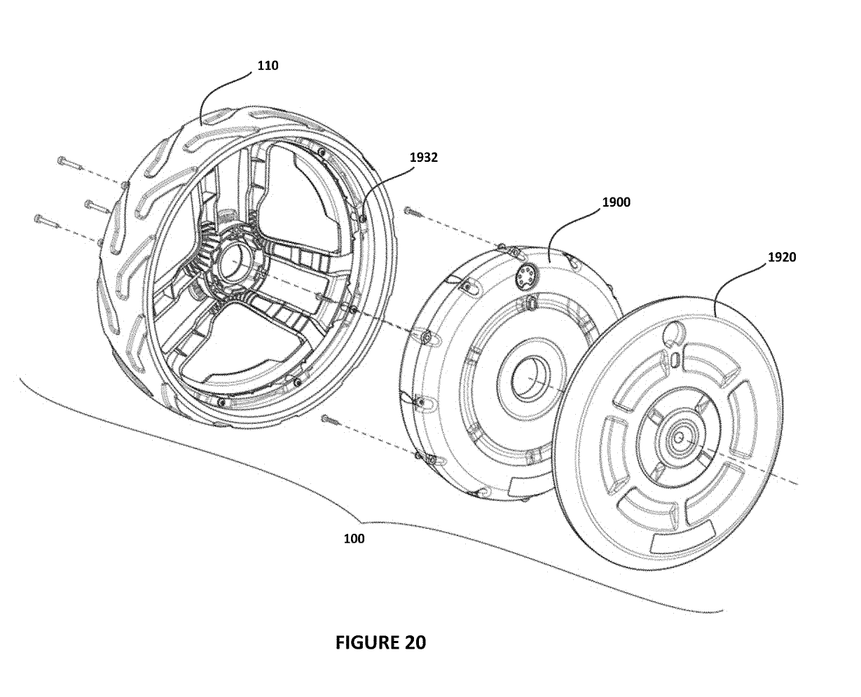

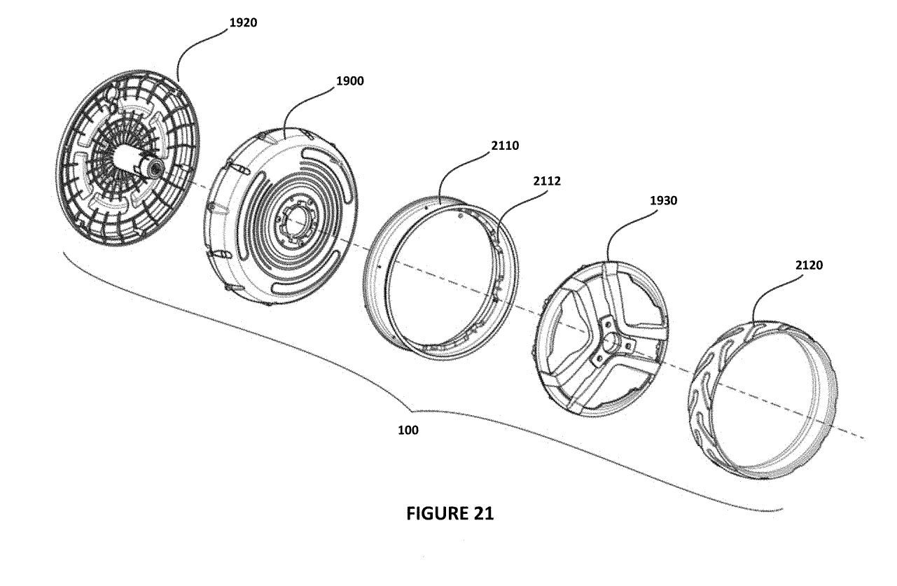

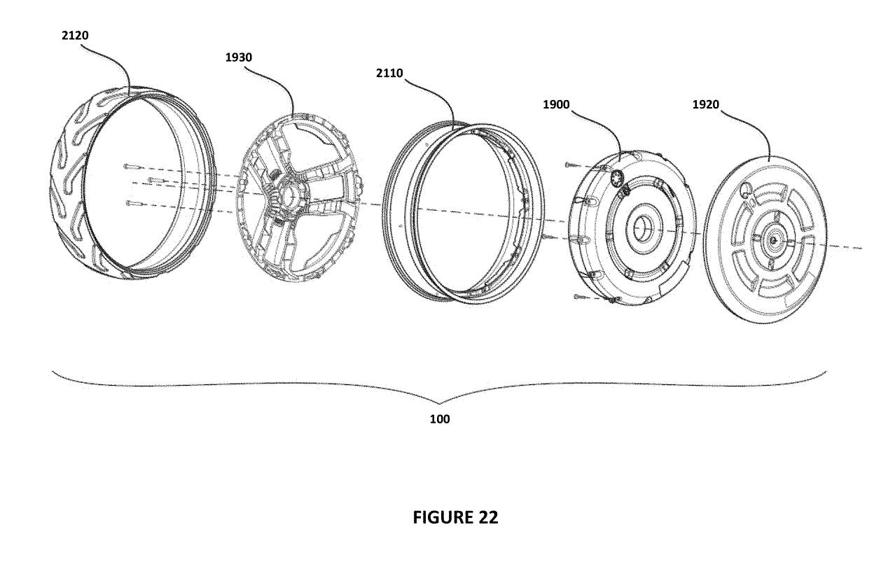

Referring to FIGS. 21 and 22, the ground engaging assembly 110 includes an outer frame 1930 which is secured to the hub 2420, a rim 2110 coupled to the outer frame 1930 that surrounds a perimeter of the housing 1902, and a tyre 2120 secured to the rim 2110. As shown in FIGS. 19 and 20, the outer frame 1930 is coupled to the rim 2110 via a plurality of screws 1932 which are received through mounting tabs 2112 on the inner surface of the rim 2110. The tyre 2120 is received over the circumference of the rim 2110. The outer frame 1930 is secured to the hub 2420 via further screws 1934 which project through holes 1936 in the outer frame 1930 and are threadably engaged by threaded holes 2432 in the mounting surface 2430 of the hub 2420. Protrusions on the mounting surface of the hub 2420 engage with apertures on an inner surface of the outer frame 1930. Once the ground engaging assembly 110 is attached to the transmission and control module 1900, the transmission and control module 1900 sits within a compartment defined by the width of the rim 2110. The housing 1902 of the transmission and control module 1900 is clear of contact with the rim 2110 and tyre 2120. As the rotation of the hub 2420 causes rotation of the ground engagement assembly 110 due to being directly coupled to the hub 2420 via the outer frame 1930, the ground engagement assembly 110 rotates freely about the housing 1902 of the transmission and control module 1900.

As shown in FIGS. 19 and 20, the inner cover 1920 is secured to the housing 1902 via a plurality of screws 1922. As such, the inner cover 1920 does not rotate relative to the housing 1902 which also remains stationary during rotational operation of the electrically motorised wheel 100. The inner cover 1920 has a central hole 1924 for locating the coupling assembly 125 which receives the axle 2000, and one or more mounting holes 1926 located about the central hole 1924 for receiving the mounting member 1010 such as a mounting leg provided in the form of a drive pin extending from or attached to the vehicle.

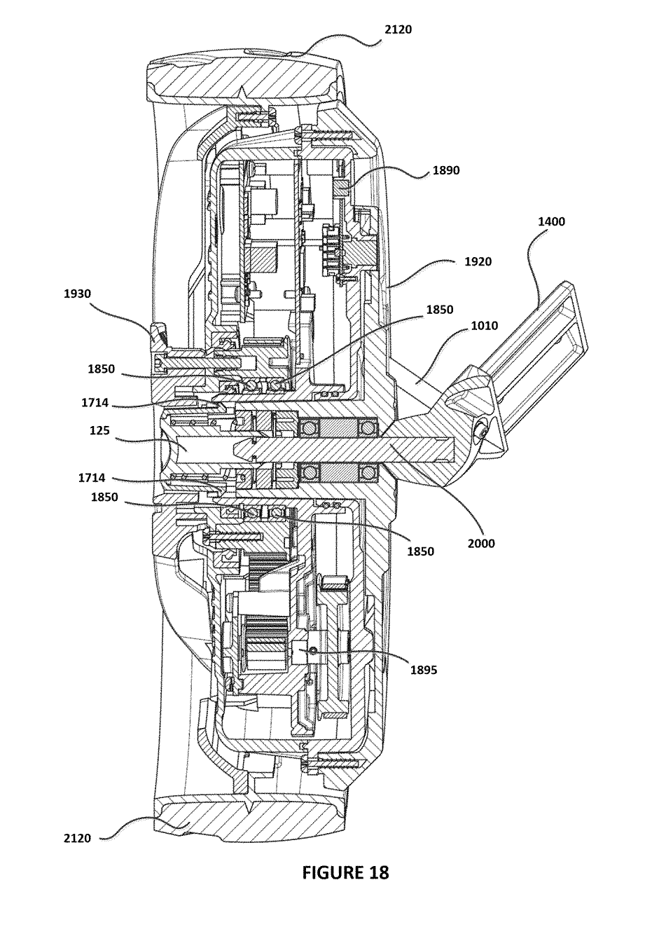

As shown in FIG. 17, the central hole 1924 of the inner cover 1920 extends inwardly defining a hollow column 1928 which houses the coupling assembly 125. The coupling assembly 125 includes a cap 1710 having a plurality of resilient fingers 1712, wherein each finger 1712 includes a notched end 1714 which engages a respective hole 1929 in the hollow column 1928 to retain the coupling assembly 125 within the column 1928 in an assembled state. The coupling assembly 125 includes a spring 1290 which axially biases against push actuation of the actuator 1220 provided with a stem having a camshaft 1226 having a push button 290 rotational interface. As described in relation to FIG. 11, the coupling assembly 125 includes a pair of spaced retaining clips 1240, 1250 which splay and close in an out-of-phase manner in response to axial movement of the camshaft 1226 to allow axial movement of the axle 2000 within the coupling assembly 125 so as to engage a groove of the axle 2000 in the first or second coupled position as previously described in an earlier example. The retaining clips 1240, 1250 are retained and spaced by spacer assembly 1770. In the engaged coupling position, the mounting leg 1010 is engaged within one of the mounting holes 1926 provided on the external surface of the inner cover 1920. In the disengaged coupling position, the mounting leg 1010 is withdrawn from the respective mounting hole 1926 of the inner cover 1920 such that the housing 1902 of the transmission and control module 1900 is able to freely rotate about the axle 2000. As shown in FIGS. 17 and 18, the coupling assembly 125 includes a pair of spaced bearings 1750, 1760 that rotationally support the partially withdrawn axle 2000 to facilitate free-wheeling rotation of the transmission and control module 1900 about the axle 2000 when in the disengaged coupled position. The bearings 1750, 1760 are spaced by spacer 1755 located therebetween.

Referring to FIGS. 24 and 25, the transmission and control module 1900 includes a chassis 2450 which is secured within the housing 1902 such that the chassis 2450 is rotationally stationary within the housing 1902 during motorised rotation of the electrically motorised wheel 100. The hub 2420 is supported upon the chassis 2450 via one or more bearings 1850 as shown in FIG. 18 such that the hub 2420 is rotatable relative to the chassis 2450 during motorised rotation of the electrically motorised wheel.

Continuing to refer to FIGS. 24 and 25, the transmission assembly 2410 includes a gear box assembly 2460 which is operatively coupled to the electric motor 560. The gear box assembly 2460 includes a gear box housing 2462 which is supported within the housing 1902 by one or more vibration dampeners 2464. The vibrational dampeners 2464 are provided on the head of fasteners such as screws which fasten to holes on the inner surface of the housing portion of the transmission and control module 1900. The dampeners 2464 that support and contact the gear box assembly 2460 have been found to reduce vibrational noise generated by the transmission and control module 1900 during motorised rotational operation.

As shown in FIGS. 24 and 25, the transmission assembly 2410 further includes a belt and pulley arrangement 2470 which is at least partially supported upon the chassis 2450 which is operatively connected between the gear box assembly 2460 and the hub 2420. As shown in FIG. 25, the gear box housing 2462 is separated from the chassis 2450 and rest upon one or more further vibration dampeners 2466. The separation of the gear box housing 2462 from the chassis 2450 has been found to reduce vibrational noise generated by the transmission and control module 1900 during motorised rotational operation.

As shown in FIG. 24, the gear box housing 2462 supports a pulley 2472 which is operatively connected to the gear box assembly 2460 which includes a bevelled gear arrangement. The pulley 2472 is further operatively connected to another pulley 2474 which is part of the belt and pulley arrangement 2470 via a first belt 2476. A further pulley operatively connected to the another pulley 2474 turns which in turn is operatively connected to the hub 2420 via a second belt 2478.

As shown in FIGS. 24 and 25, the housing 1902 of the transmission and control module 1900 includes a first hollow 1909 passing therethrough, and the chassis 2450 has a second hollow 2455 passing therethrough. The first and second hollows 1909, 2450 are coaxially aligned to locate therein the coupling mechanism 125 for coupling the axle 2000 as shown in FIG. 23. As shown in FIGS. 24 and 25, the second hollow 2450 of the chassis 2450 is defined by an open ended cylindrical section which rotatably supports thereabout the hub 2420 by the one or more bearings 1850.

Referring to FIG. 20, the transmission and control module includes a power source indicator 2010 which is in electrical connection with at least one of the controller 510 and the electric power source 520. As shown in FIG. 13, the power source indicator 2010 is exposed by the housing 1902 to provide an indication of a level of electrical power stored by the power source 520. The transmission and control module 1900 includes a charging device 2015 having a charging port 2020 exposed by the housing 1902, wherein the charging device 2015 is in electrical connection with the power source 520. As shown in cross-section in FIG. 18, the charging port 2020 has a magnet 1890 in order to magnetically retain a connector of an external electrical power source to the charging port 2020.

Referring to FIGS. 28 and 29 there are shown examples of the user command device 570 and a dock 2900 for attachment to the vehicle for docking the user command device 570. The electrical components of the user command device for FIG. 28 is in common with that previously discussed in relation to FIG. 5 and therefore for the purposes of clarity will not be repeated but should be incorporated into the following examples which relate to the user command device.

The dock 2900 includes a one or more magnets 2910 and the user command device includes a ferromagnetic rear surface. Magnetic attraction between the one or more magnets 2910 of the dock and the ferromagnetic surface of the user command device 570 releasably retain the user command device 570 in a docked position.

As shown in FIG. 5, the controller 571 of user command device 570 includes or is coupled to a docking sensor 579 provided in the form of a magnetic field sensor such as a hall effect sensor. In the docked position the magnetic field sensor 579 senses the one or more magnets 2910 of the dock 2900 and transfers an initialisation request to the one or more electrically motorised wheels 100 to perform an initialisation process. As such, the magnets 2910 advantageously perform a dual purpose (releasable retention and used for detecting a mounting status). In response to each wheel controller 510 receiving an initialisation request from the user command device 570, the respective controller 510 is configured to establish a wireless communication session with the user command device 570. In addition, the controller 510 is configured to determine the mounting orientation which is then set in memory 514 of the controller 510 such that the motor 560 is rotated in a direction appropriate for the respective mounting orientation.

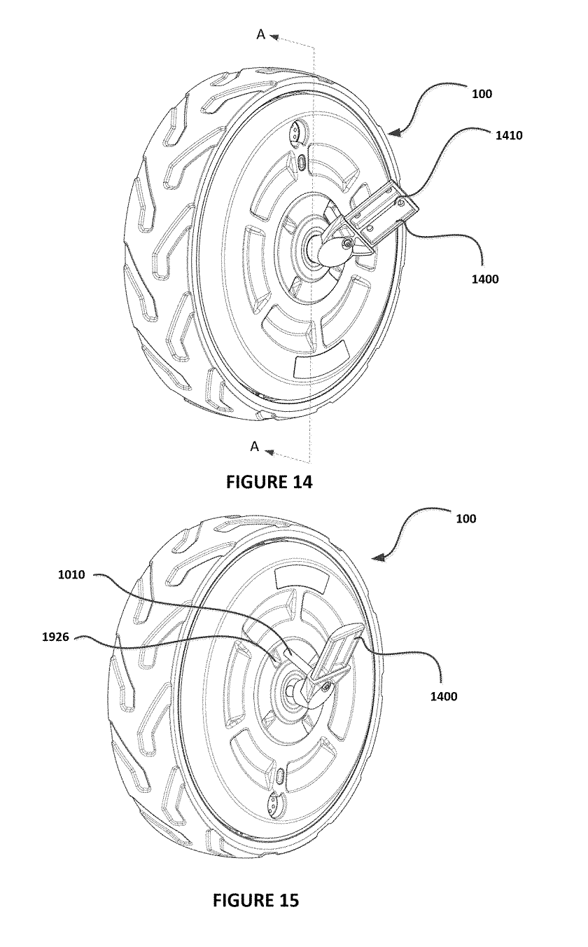

Whilst in some instances the frame 2610 of the vehicle 2700 may include an axle 2000 provided in the for of a stud axle and a mounting leg 1010, in a number of instances an adaptor 1400 may need to be attached to the vehicle to provide a suitable axle 2000 and mounting leg 1010 for coupling with the electrically motorised wheel(s) 100. As shown in FIG. 14, the mounting adaptor 1400 has a mounting surface 1410 for mounting the mounting adaptor 1400 to the wheel supporting portion of the non-motorised vehicle. Fasteners may be used to mount the mounting surface 1410 to the vehicle. Various types of mounting adaptors can be provided having different mounting surfaces 1410 for different types of mounting arrangements used by different vehicles provided by different manufacturers. A mounting adaptor 1400 can be coupled to each wheel supporting portion of the non-motorised wheeled vehicle, wherein each mounting adaptor 1400 provides the mounting leg 1010 and an axle 2000 for releasable coupling by one of the coupling assemblies 125 of one of the electrically motorised wheels 100. The mounting leg 1010 which engages a portion of the housing 1902 or inner cover 1920 of the respective electrically motorised wheel 100 is non-coaxial with the respective axle 2000. In one form, the non-mounting leg 1010 is angularly offset from the vertical between 25 to 30 degrees, and in a preferable form approximately 28 degrees.

As shown in FIG. 24, the transmission and control module 1900 can include an inner seal 2496 and an outer seal 2498 to restrict ingress of foreign material and substances from entering into the housing 1902.

As discussed, the controller 515 can operate in a sleep mode and an operational mode. The controller 515 is awoken from the sleep mode in response to receiving an initialisation request from the user command device 570, wherein in response a number of initialisation steps are undertaken. The controller 571 of the user command device 570 also operates in a sleep mode and an operational mode. In response to the user providing input via the input device 577 or the controller receiving one or more signals from the docking sensor 579 indicative of the user command device being docked, the controller 571 generates and transfers the initialisation request to the one or more wheels 100 and undertakes establishment of the wireless communication session with the controller(s) 515 of the one or more wheels 100. Both controllers 571 and 515 are configured to return to a sleep mode in the event that there is no command provided by the user command device to the one or more wheels 100 for a threshold period of time (e.g. 30 mins) or alternatively in response to user input via the input device 577. It will therefore be appreciated that in this configuration, unlike other examples, the controllers do not need to be switched on or off but rather transition between sleep modes and operational modes.

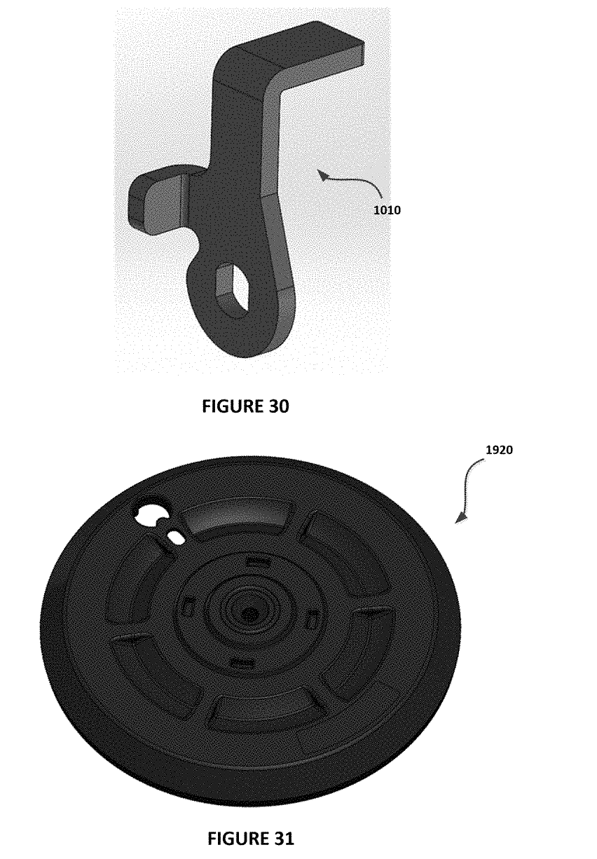

Referring to FIG. 30 there is shown an alternate mounting member 1010 for engaging with one of the mounting holes of the inner surface of the wheel such as the inner cover 1920. FIG. 31 also shows an alternate inner cover 1920 and coupling assembly 125 which includes corresponding profiled mounting holes for the mounting member shown in FIG. 30. As can be seen in FIG. 30, the mounting member includes a square or rectangular profiled projection which is receivable within one of the square or rectangular profiled holes provided about the edge of the coupling assembly 125. In one particular form, this alternate mounting member 1010 can be integral with the vehicle such as coupled to the frame of the vehicle. In the instance of golf carts, golf carts may be provided to golf courses for hire to customers which include the mounting member 1010 as shown in FIG. 30. In addition, a plurality of electrically motorised wheels having the inner cover 1920 as shown in FIG. 31 may also be provided to golf course for hire. However, the mounting member having the rounded or pointed profile as well as electrically motorised wheels having the round mounting holes as shown in previous examples may be provided to the general public. In this arrangement, a person wishing to hire a non-motorised golf cart will be unable to couple their own electrically motorised wheels as the square or rectangular profiled mounting member of the hired golf cart will not be received within the circular profiled mounting holes of their electrically motorised wheel. Thus, the user can be required to also hire the corresponding electrically motorised wheel from the golf course in or to convert the non-motorised golf cart into a motorised golf cart.

It will be appreciated that whilst embodiments have been described which show an inner cover 1920 which has one or more mounting holes 1926 for receiving a mounting member 1010 of the vehicle 2700, it will be appreciated that in other arrangements, the inner housing portion 1904 could alternatively include a one or more mounting holes 1926 in the external inner surface, wherein at least one of the mounting holes 1926 receives the mounting member, thereby eliminating an inner cover 1920.

Whilst in the above examples an outer frame has been described to connect the ground engaging assembly 110 to the hub 1920, it will be appreciated that the outer frame could be an outer cover.

In certain embodiments, the electrically motorised wheel 100 is an electrically motorised golf cart to convert a non-motorised golf cart to an electrically motorised golf cart. In one particular form, electrically motorised golf cart wheels can be coupled to a golf cart as described by the Applicant in PCT/AU2016/050022, the contents of which is herein incorporated by reference. However, it will be appreciated that the electrically motorised wheel 100 may be coupled to other non-motorised wheeled vehicles. For example, the electrically motorised wheel 100 may be coupled to prams, trolleys, hospital beds, or any wheeled conveyance.

In one optional form, the user command device 570 may be a mobile communication device such as a smart phone device which executes a computer application stored in memory. A touch screen interface of the smart phone device can be used to receive input from the user and present output to the user.

In another optional form, the communication device of the electrically motorised wheel(s) 100 and/or the user command device 570 may transfer diagnostic data to a server processing system via a wide area network such as the Internet. The server processing system can perform a diagnostic analysis upon the received data and then transfer results of the diagnostic to the user via a user processing system or the user command device 570. The results of the diagnostic analysis may recommend maintenance be performed on the electrically motorised wheel(s) 100.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1. An electrically motorised wheel to releasably couple to and convert a non-motorised wheeled vehicle to an electrically motorised vehicle, wherein the electrically motorised wheel includes:
a ground engaging assembly;
a coupling assembly for releasably coupling the electrically motorised wheel to an axle of the vehicle; and
a housing configured to house:
an electric motor operatively coupled to the ground engaging assembly;
a control system including or coupled to an inertial measurement unit, which is stationary within the housing during motorised rotation of the electrically motorised wheel, and a controller configured to control operation of the electric motor based one or more sensor signals received from the inertial measurement unit; and
a power source electrically connected to the control system and the electric motor.

2. The electrically motorised wheel according to claim 1, wherein the inertial measurement unit includes a three axis gyroscope and a three axis accelerometer.

3. The electrically motorised wheel according to claim 1 or 2, wherein the coupling assembly is configured to releasably couple the electrically motorised wheel to the axle of the vehicle in a first coupled position where rotation of the ground engaging assembly is controlled by the electric motor, and a second coupled position where rotation of the ground engaging assembly is not controlled by the electric motor.

4. The electrically motorised wheel according to claim 3, wherein the coupling assembly includes a pair of axially separated engagement components and an engagement actuator component, wherein actuation of the engagement actuator component causes the pair of axially separated engagement components to move between an engaged position and a disengaged position so as to allow the electrically motorised wheel to be axially movable between the first coupled position and the second coupled position.

5. The electrically motorised wheel according to claim 4, wherein the pair of axially separated engagement components include a first and second retaining clip, and wherein the engagement actuator component is a camshaft, wherein actuation of the camshaft simultaneously causes the first retaining clip to move from the engaged position to the disengaged position and the second retaining clip to move from the disengaged position to an intermediary position, wherein axial movement of the electrically motorised wheel causes a groove of the axle to align with the second retaining clip and self bias to the engaged position to engage the axle.

6. The electrically motorised wheel according to any one of claims 1 to 5, wherein the electric motor is a bidirectional electric motor, wherein a direction of operation of the electric motor is controlled by the controller based on sensed acceleration indicated by the one or more sensor signals received from the inertial measurement unit.

7. The electrically motorised wheel according to claims 1 to 6, wherein the control system includes memory having stored therein mounting orientation data, wherein the controller uses the sensed acceleration indicated by the one or more sensor signals and the mounting orientation data to determine a mounting orientation of the electrically motorised wheel, wherein the direction of operation of the electric motor is controlled according to the mounting orientation.

8. The electrically motorised wheel according to claim 7, wherein the mounting orientation data includes a plurality of angular rotation ranges, wherein each angular rotation range has a respective mounting orientation, wherein the controller is configured to:
determine, based on the sensed acceleration indicated by the one or more sensor signals, a current angular rotation; and
determine a matching angular rotation range from the plurality of angular rotation ranges which the current angular rotation falls within, wherein the mounting orientation of the electrically motorised wheel is the respective mounting orientation of the matching angular rotation range.

9. The electrically motorised wheel according to any one of claims 1 to 8, wherein the control system is configured to control an operating speed of the electric motor based on an angular velocity indicated by the one or more sensor signals received from the inertial measurement unit.

10. The electrically motorised wheel according to any one of claims 1 to 9, further including a wireless communication device in communication with the controller for receiving a command signal from a user command device, wherein the controller operates the electric motor based upon the command signal.

11. The electrically motorised wheel according to claim 10, wherein in response to the controller receiving an initialisation request from the user command signal, the controller is configured to establish a wireless communication session with the user command device.

12. The electrically motorised wheel according to any one of claims 1 to 11, wherein the housing at least partially houses a transmission assembly operatively connected between the electric motor and the ground engaging assembly, wherein the transmission assembly is configured to cause rotation of a ground engaging assembly of the electrically motorised wheel in response to actuation of the electric motor.

13. The electrically motorised wheel according to claim 12, wherein transmission assembly includes a hub having a mounting surface that is exposed from the housing which rotates relative to the housing.

14. The electrically motorised wheel according to claim 13, wherein the mounting surface includes a fastening arrangement to operatively connect a ground engaging assembly of the electrically motorised wheel to the hub such that rotation of the hub causes the ground engaging assembly to rotate therewith.

15. The electrically motorised wheel according to claim 13 or 14, wherein the ground engaging assembly includes:
an outer frame which is secured to the hub;
a rim coupled to the outer frame that surrounds a perimeter of the housing; and
a tyre secured to the rim.

16. The electrically motorised wheel according to claim 18, further including an inner cover which is secured to the housing, wherein the inner cover has a central hole for locating the coupling assembly, and one or more mounting holes located about the central hole for receiving a mounting leg, wherein the mounting leg is part of or coupled to the non-motorised wheeled vehicle.

17. The electrically motorised wheel according to claim 16, wherein the central hole of the inner cover extends inwardly defining a hollow column housing the coupling assembly.

18. The electrically motorised wheel according to claim 20, wherein the coupling assembly includes a cap having a pair of resilient fingers, wherein each finger includes a notched end which engages a respective hole in the hollow column to retain the coupling assembly within the shaft in an assembled state.

19. The electrically motorised wheel according to any one of claims 13 to 18, further including a chassis which is secured within the housing such that the chassis is rotationally stationary within the housing during motorised rotation of the electrically motorised wheel, wherein the hub is supported upon the chassis via a bearing such that the hub is rotatable relative to the chassis during motorised rotation of the electrically motorised wheel.

20. The electrically motorised wheel according to claim 19, wherein the transmission assembly includes a gear box assembly which is operatively coupled to the electric motor, wherein the gear box assembly includes a gear box housing which is supported within the housing by one or more vibration dampeners.

21. The electrically motorised wheel according to claim 20, wherein the transmission assembly further includes a pulley arrangement which is at least partially supported upon the chassis which is operatively connected between the gear box assembly and the hub.

22. The electrically motorised wheel according to claim 21, wherein the gear box housing is separated from the chassis by one or more further vibration dampeners.

23. The electrically motorised wheel according to claim 22, wherein the gear box housing supports a pulley which is operatively connected to the gear box assembly, wherein the pulley is further operatively connected to at least part of the pulley arrangement via a belt.

24. The electrically motorised wheel according to any one of claims 12 to 23, wherein the controller includes a magnetic field sensor which is located substantially adjacent a portion of the hub, wherein the hub has embedded therein one or more magnets, wherein the controller is configured to:
receive, from the magnetic field sensor, one or more magnetic field sensor signals indicative of a rotational speed of the hub;
receive, from a motor controller of the motor, a signal indicative of a rotational speed of the motor; and
determining if a ratio of the rotational speed of the hub and the rotational speed of the motor changes over time, wherein in response to determining the change the controller is configured to stop operation of the motor.

25. The electrically motorised wheel according to any one of claims 1 to 24, wherein the housing includes a first hollow passing therethrough, and the chassis has a second hollow passing therethrough, wherein the first and second hollows are coaxially aligned to locate therein the coupling mechanism for coupling the axle.

26. The electrically motorised wheel according to claim 25, wherein the second hollow of the chassis is defined by an open ended cylindrical section which rotatably supports thereabout the hub.

27. The electrically motorised wheel according to any one of claims 1 to 26, further including a power source indicator which is in electrical connection with at least one of the controller and the electric power source, wherein the power source indicator is exposed by the housing to provide an indication of a level of electrical power stored by the power source.

28. The electrically motorised wheel according to any one of claims 1 to 27, further including a charging device having a charging port exposed by the housing, wherein the charging device is in electrical connection with the power source.

29. The electrically motorised wheel according to claim 28, wherein the charging port has a magnet in order to magnetically retain a connector of an external power source to the charging port.

30. The electrically motorised wheel according to any one of claims 1 to 29, wherein the electrically motorised wheel is an electrically motorised golf cart wheel to convert a non-motorised golf cart to an electrically motorised golf cart.

31. A transmission and control module for an electrically motorised wheel, wherein the transmission and control module includes:
a housing;
an electric motor housed within the housing;
a transmission assembly operatively connected to the electric motor and at least partially housed within the housing, wherein the transmission assembly is configured to cause rotation of a ground engaging portion of the electrically motorised wheel;
a control system housed within the housing and electrically coupled to the electric motor, wherein the control system includes or is coupled to an inertial measurement unit, which is stationary within the housing during motorised rotation of the electrically motorised wheel, and a controller configured to control operation of the electric motor based one or more sensor signals received from the inertial measurement unit; and
a power source housed within the housing and electrically connected to the control system and the electric motor.

32. The transmission and control module according to claim 31, wherein the electric motor is a bidirectional motor, wherein a direction of operation of the electric motor is controlled by the control system based on sensed acceleration indicated by the one or more sensor signals received from the inertial measurement unit.

33. The transmission and control module according to claim 32, wherein the control system includes a memory device having stored therein mounting orientation data, wherein the controller uses the sensed acceleration indicated by the one or more sensor signals and the mounting orientation data to determine a mounting orientation of the electrically motorised wheel, wherein the direction of operation of the electric motor is controlled according to the mounting orientation.

34. The transmission and control module according to claim 33, wherein the mounting orientation data includes a plurality of angular rotation ranges, wherein each angular rotation range has a respective mounting orientation, wherein the controller is configured to:
determine, based on the acceleration indicated by the one or more sensor signals, a current angular rotation; and
determine a matching angular rotation range from the plurality of angular rotation ranges which the current angular rotation falls within, wherein the mounting orientation of the electrically motorised wheel is the respective mounting orientation of the matching angular rotation range.

35. The transmission and control module according to any one of claims 31 to 34, wherein the control system is configured to control an operating speed of the electric motor based on an angular velocity indicated by the one or more sensor signals received from the inertial measurement unit.

36. The transmission and control module according to any one of claims 31 to 35, wherein transmission assembly includes a hub having a mounting surface that is exposed from the housing which rotates relative to housing.

37. The transmission and control module according to claim 36, wherein the mounting surface includes a fastening arrangement to operatively connect a ground engaging portion of the electrically motorised wheel to the hub such that rotation of the hub causes the ground engaging portion to rotate therewith.

38. The transmission and control module according to any one of claim 38 or 39, wherein the transmission and control module includes a chassis which is secured within the housing such that the chassis is rotationally stationary within the housing during motorised rotation of the electrically motorised wheel, wherein the hub is supported upon the chassis via a bearing such that the hub is rotatable relative to the chassis during motorised rotation.

39. The transmission and control module according to claim 38, wherein the transmission assembly includes a gear box assembly which is operatively coupled to the electric motor, wherein the gear box assembly includes a gear box housing which is supported within the housing by one ore more vibration dampeners.

40. The transmission and control module according to claim 39, wherein the transmission assembly further includes a pulley arrangement at least partially supported upon the chassis which is operatively connected between the gear box assembly and the hub.

41. The transmission and control module according to claim 40, wherein the gear box housing is separate to the chassis and spaced apart by one or more further vibration dampeners.

42. The transmission and control module according to claim 41, wherein the gear box housing supports a pulley which is operatively connected to the gear box assembly, wherein the pulley is further operatively connected to at least part of the pulley arrangement via a belt.

43. The transmission and control module according to any one of claims 36 to 42, wherein the controller includes a magnetic field sensor which is located substantially adjacent a portion of the hub, wherein the hub has embedded therein one or more magnets, wherein the controller is configured to:
receive, from the magnetic field sensor, one or more magnetic field sensor signals indicative of a rotational speed of the hub;
receive, from a motor controller of the motor, a signal indicative of a rotational speed of the motor; and
determining if a ratio of the rotational speed of the hub and the rotational speed of the motor changes over time, wherein in response to determining the change the controller is configured to stop operation of the motor.

44. The transmission and control module according to any one of claims 31 to 43, further including a wireless communication device in communication with the controller for receiving a user command signal from a user command device, wherein the controller operates the electric motor based upon the user command signal.

45. The transmission and control module according to claim 44, wherein in response to the controller receiving an initialisation request from the user command device, the controller is configured to establish a wireless communication session with the user command device.

46. The transmission and control module according to any one of claims 31 to 45, wherein the housing includes a first hollow passing therethrough, and the chassis has a second hollow passing therethrough, wherein the first and second hollows are coaxially aligned to locate therein a coupling mechanism for coupling an axle of the electrically motorised wheel.

47. The transmission and control module according to claim 46, wherein the second hollow of the chassis is defined by an open ended cylindrical section which rotatably supports thereabout the hub.

48. The transmission and control module according to any one of claims 31 to 47, further including a power source indicator which is in electrical connection with at least one of the controller and the electric power source, wherein the power source indicator is exposed by the housing to provide an indication of a level of electrical power stored by the power source.

49. The transmission and control module according to any one of claims 31 to 48, further including a charging device including a charging port exposed by the housing, wherein the charging device is in electrical connection with the power source.

50. The transmission and control module according to claim 49, wherein the charging port has a magnet in order to magnetically retain a connector of an external power source to the charging port.

51. A kit for converting a non-motorised wheeled vehicle to an electrically motorised vehicle, wherein the kit includes a first electrically motorised wheel and a second electrically motorised wheel according to any one of claims 1 to 30.

52. The kit according to claim 51, wherein the kit includes a plurality of mounting adaptors to couple to a wheel supporting portion of the non-motorised wheeled vehicle, wherein each mounting adaptor provides the axle for releasable coupling by one of the coupling assemblies of one of the electrically motorised wheels.

53. The kit according to claim 52, wherein each mounting adaptor includes a mounting leg which engages a portion of the housing of the respective electrically motorised wheel, wherein the mounting leg is non-coaxial with the respective axle.

54. The kit according to any one of claims 51 to 53, wherein the kit includes a user command device configured to:
receive, via an input device, a user command; and
transfer, to the control system of the first and second electrically motorised wheels, a signal indicative of or based upon the user command.

55. The kit according to claim 54, wherein the kit includes a dock for attachment to the electrically motorised vehicle for docking the user command device, wherein the dock includes a one or more magnets and the user command device includes a ferromagnetic surface, wherein magnetic attraction between the one or more magnets of the dock and the ferromagnetic surface of the command device releasably retain the user command device in a docked position.

56. The kit according to claim 55, wherein the user command device includes a controller including or coupled to a magnetic field sensor, wherein in the docked position the magnetic field sensor senses the one or more magnets of the dock and transfers an initialisation request to the first and second electrically motorised wheels to perform an initialisation process.

57. The kit according to any one of claims 51 to 56, wherein the kit converts a non-motorised golf cart into an electrically motorised golf cart.

58. An electrically motorised vehicle including:
non-motorised wheeled vehicle; and
a first electrically motorised wheel and a second electrically motorised wheel, wherein each electrically motorised wheel is adapted to the non-motorised wheeled vehicle and configured according to any one of claims 1 to 30.

59. The electrically motorised vehicle according to claim 58, wherein a plurality of mounting adaptors are coupled to a wheel supporting portion of the non-motorised wheeled vehicle, wherein each mounting adaptor provides the axle for releasable coupling by one of the coupling assemblies of one of the electrically motorised wheels.

60. The electrically motorised vehicle according to claim 59, wherein each mounting adaptor includes a mounting leg which engages a portion of the housing of the respective electrically motorised wheel, wherein the mounting leg is non-coaxial with the respective axle.

61. A system including:
the electrically motorised vehicle according to any one of claims 57 to 59, wherein the system includes a user command device configured to:
receive, via an input device, a user command; and
transfer, to the control system of at least one of the first and second electrically motorised wheels, a signal indicative of or based upon the user command for operating the respective electric motor of at least one of the first and second electrically motorised wheels.

62. The system according to claim 61, further including a dock attached to the electrically motorised vehicle for docking the user command device, wherein the dock includes a one or more magnets and the user command device includes a ferromagnetic surface, wherein magnetic attraction between the one or more magnets of the dock and the ferromagnetic surface of the command device releasably retain the user command device in a docked position.

63. The system according to claim 62, wherein the user command device includes a controller including or coupled to a magnetic field sensor, wherein in the docked position the magnetic field sensor senses the one or more magnets of the dock and transfers an initialisation request to the first and second electrically motorised wheels to perform an initialisation process.
